(19) United States
(12) Patent Application Publication
(10) Pub. No.: US 2018/0051103 A1
(43) Pub. Date: Feb. 22, 2018

(54) OLIGOMER PRODUCTION METHOD AND CATALYST

(71) Applicant: JXTG NIPPON OIL & ENERGY CORPORATION, Tokyo (JP)

(72) Inventors: Fuyuki AIDA, Tokyo (JP); Kazuo TAGAWA, Tokyo (JP)

(73) Assignee: JXTG NIPPON OIL & ENERGY CORPORATION, Tokyo (JP)

(21) Appl. No.: 15/556,848

(22) PCT Filed: Mar. 16, 2016
(86) PCT No.: PCT/JP2016/058407

§ 371 Date: Sep. 8, 2017

(30) Foreign Application Priority Data
Mar. 17, 2015 (JP) 2015-053821
Jun. 5, 2015 (JP) 2015-114688

(51) Int. Cl. C08F 4/70; C07F 7/00; C08F 210/02; C08F 4/6592; C07F 15/02

(52) U.S. Cl. CPC C08F 4/70; C07F 7/006; C07F 15/02; C08F 4/6592; C08F 210/02

(57) ABSTRACT

An oligomer production method and a catalyst, the method comprising a step of co-oligomerizing a polymerizable monomer including ethylene and an α-olefin in the presence of a catalyst containing (A) a compound represented by a formula (1), (B) a compound represented by a formula (2), (C) methylaluminoxane and/or a boron compound and (D) an organozine compound and/or an organoaluminun compound other than methylaluminoxane, and an oligomer production method and a catalyst comprising a step of oligomerizing a polymerizable monomer including an olefin in the presence of a catalyst containing a complex of a ligand being a diimine compound represented by a formula (3) and a metal of Group 8 elements, etc.

### TECHNICAL FIELD

The present invention relates to an oligomer production method and a catalyst, in particular, a method and a catalyst for producing an oligomer from a polymerizable monomer including an olefin.

### BACKGROUND ART

As catalysts used for the copolymerization of ethylene and an α-olefin, catalysts consisting of a metallocene compound and methylaluminoxane, palladium catalysts, iron complexes, cobalt complexes and the like are known (Non Patent Literatures 1 to 3, Patent Literatures 1 to 3).

Iron complexes are also known as a catalyst for ethylene polymerization (Non Patent Literatures 4 to 6).

Further, as catalysts for producing block copolymers, diethylzinc, a metallocene compound, and a catalyst consisting of a palladium catalyst and dialkylzinc are known (Non Patent Literature 7, Patent Literature 4).

### CITATION LIST

### Patent Literature

Patent Literature 1: JP 2000-516295 A
Patent Literature 2: JP 2002-302510 A
Patent Literature 3: CN 102432415 A
Patent Literature 4: JP 2007-529616 A

### Non Patent Literature

Non Patent Literature 1: “Macromol. Chem. Phys.”, Vol. 197, 1996, p. 3907
Non Patent Literature 2: “J. Am. Chem. Soc.”, Vol. 117, 1995, p. 6414
Non Patent Literature 3: “J. Am. Chem. Soc.”, Vol. 120, 1998, p. 7143
Non Patent Literature 4: “J. Mol. Cat. A: Chemical”, Vol. 179, 2002, p. 155
Non Patent Literature 5: “Appl. Cat. A: General”, Vol. 403, 2011, p. 25
Non Patent Literature 6: “Organometallics”, Vol. 28, 2009, p. 3225
Non Patent Literature 7: “Science”, Vol. 312, 2006, p. 714

### SUMMARY OF INVENTION

### Technical Problem

The present invention has an object to provide an oligomer production method and a catalyst capable of, in the oligomerization of a polymerizable monomer including an olefin, efficiently growing an oligomer to be obtained to have an intended molecular weight and sufficiently suppressing the progression of polymerization.

Further, in one aspect, the present invention has an object to provide an oligomer production method and a catalyst capable of, in the copolymerization of a polymerizable monomer including ethylene and an α-olefin, obtaining a co-oligomer with good copolymerizability.

Further, in another aspect, the present invention has an object to provide an oligomer production method and a catalyst capable of efficiently producing an oligomer having a narrow molecular weight distribution from a polymerizable monomer including an olefin.

Furthermore, in still another aspect, the present invention has an object to provide an oligomer production method and a catalyst capable of, in the oligomerization of a polymerizable monomer including an olefin, increasing a catalytic efficiency and maintaining the polymerization activity for an extended period of time.

### Solution to Problem

In other words, the present invention provides a method for producing an oligomer, the method comprising a step of co-oligomerizing a polymerizable monomer including ethylene and an α-olefin in the presence of a catalyst containing (A) a rac-ethylidene indenyl zirconium compound represented by the following formula (1), (B) an iron compound represented by the following formula (2), (C) methylaluminoxane and/or a boron compound and (D) an organozinc compound and/or an organoaluminum compound other than methylaluminoxane (hereinafter, conveniently referred to as “first production method”).

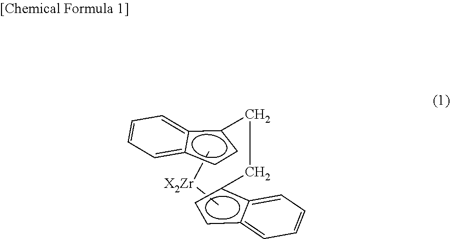

In the formula (1), X is a halogen atom, a hydrogen atom or a hydrocarbyl group having 1 to 6 carbon atoms.

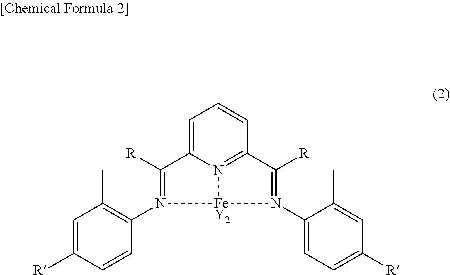

In the formula (2), R is a hydrocarbyl group having 1 to 6 carbon atoms or an aromatic group having 6 to 12 carbon atoms, a plurality of Rs in the same molecule may be the same or different, R′ is a free radical having 0 to 6 carbon atoms and an oxygen atom and/or a nitrogen atom, a plurality of R′s in the same molecule may be the same or different and Y is a chlorine atom or a bromine atom.

According to the first production method, in the oligomerization of a polymerizable monomer including an olefin, it is possible to efficiently grow an oligomer to be obtained to have an intended molecular weight and sufficiently suppress the progression of polymerization. Additionally, an ethylene-α-olefin co-oligomer with good copolymerizability can be obtained.

In the first production method, the number average molecular weight (Mn) of the co-oligomer to be obtained may be 200 to 5000.

In the first production method, the molar ratio of ethylene/α-olefin in the co-oligomer to be obtained may be within the range of 0.1 to 10.0.

The organoaluminum compound may be at least one selected from the group consisting of trimethylaluminum, triethylaluminum, triisopropylaluminum, tripropylaluminum, tributylaluminum, triisobutylaluminum, trihexylaluminum, triphenylaluminum, diethylaluminum chloride, ethylaluminum dichloride and ethylaluminum sesquichloride.

The organozine compound may be at least one selected from the group consisting of dimethylzinc, diethylzinc and diphenylzinc.

The boron compound may be at least one selected from the group consisting of trispentafluorophenylborane, lithium tetrakispentafluorophenylborate, sodium tetrakispentafluorophenylborate, N,N-dimethylanilinium tetrakispentafluorophenylborate, trityl tetrakispentafluorophenylborate, lithium tetrakis(3,5-trifluoromethylphenyl)borate, sodium tetrakis(3,5-trifluoromethylphenyl)borate, N,N-dimethylanilinium tetrakis(3,5-trifluoromethylphenyl)borate and trityl tetrakis(3,5-trifluoromethylphenyl)borate.

The present invention also provides a catalyst containing (A) a rac-ethylidene indenyl zirconium compound represented by the following formula (1), (B) an iron compound represented by the following formula (2), (C) methylaluminoxane and/or a boron compound and (D) an organozinc compound and/or an organoaluminum compound other than methylaluminoxane (hereinafter, conveniently referred to as “first catalyst”).

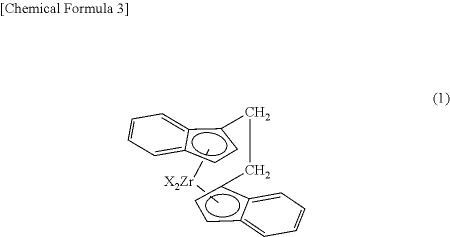

In the formula (1), X is a halogen atom, a hydrogen atom or a hydrocarbyl group having 1 to 6 carbon atoms.

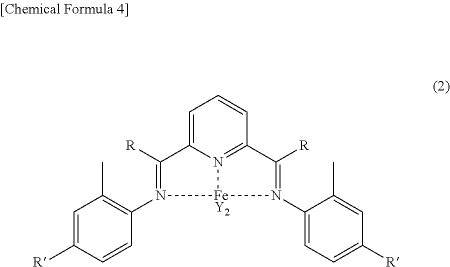

In the formula (2), R is a hydrocarbyl group having 1 to 6 carbon atoms or an aromatic group having 6 to 12 carbon atoms, a plurality of Rs in the same molecule may be the same or different, R′ is a free radical having 0 to 6 carbon atoms and an oxygen atom and/or a nitrogen atom, a plurality of R′s in the same molecule may be the same or different and Y is a chlorine atom or a bromine atom.

In another aspect, the present invention provides a method for an oligomer, the method comprising a step of oligomerizing a polymerizable monomer including an olefin in the presence of a catalyst containing a complex of a ligand being a diimine compound represented by the following formula (3) and at least one metal selected from the group consisting of Group 8 elements, Group 9 elements and Group 10 elements (hereinafter, conveniently referred to as “second production method”).

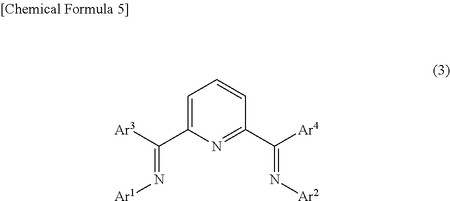

In the formula (3), Ar¹ and Ar² may be the same or different and are respectively a group represented by the following formula (4), and Ar³ and Ar⁴ may be the same or different and are respectively a group represented by the following formula (5).

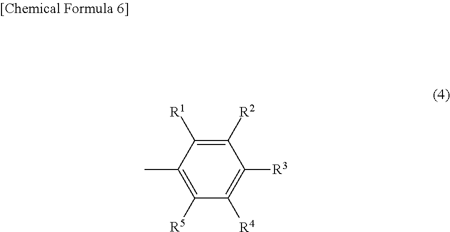

In the formula (4), R¹ and R⁵ may be the same or different and are respectively a hydrogen atom or a hydrocarbyl group having 1 to 5 carbon atoms, the total number of carbon atoms of R¹ and R⁵ is 1 or more and 5 or less, and R², R³ and R⁴ may be the same or different and are respectively a hydrogen atom or an electron-donating group.

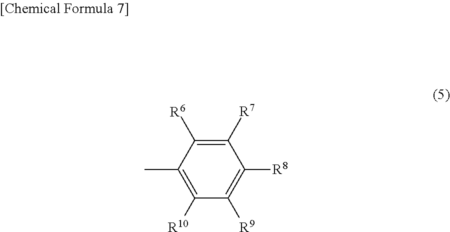

In the formula (5), R⁶ to R¹⁰ may be the same or different and are respectively a hydrogen atom or an electron-donating group.

According to the second production method, in the oligomerization of a polymerizable monomer including an olefin, it is possible to efficiently grow an oligomer to be obtained to an intended molecular weight and to sufficiently suppress the progression of polymerization. Further, an oligomer having a narrow molecular weight distribution can be efficiently produced from a polymerizable monomer including an olefin.

The above catalyst can further contain an organoaluminum compound.

Further, the present invention provides a catalyst containing a complex of a ligand being a diimine compound represented by the above formula (3) and at least one metal selected from the group consisting of Group 8 elements, Group 9 elements and Group 10 elements (hereinafter, conveniently referred to as “second catalyst”).

In another aspect, the present invention provides a method for producing an oligomer, the method comprising a step of oligomerizing a polymerizable monomer including an olefin in the presence of a catalyst containing an iron compound represented by the following formula (2) and a compound represented by the following formula (7) (hereinafter, conveniently referred to as “third production method”).

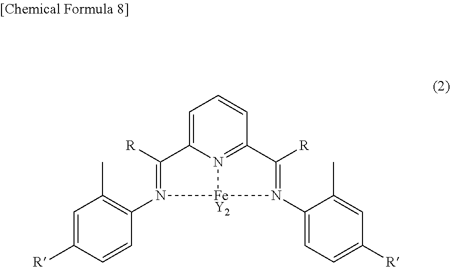

In the formula (2), R is a hydrocarbyl group having 1 to 6 carbon atoms or an aromatic group having 6 to 12 carbon atoms, a plurality of Rs in the same molecule may be the same or different, R′ is a free radical having 0 to 6 carbon atoms and an oxygen atom and/or a nitrogen atom, a plurality of R′s in the same molecule may be the same or different and Y is a chlorine atom or a bromine atom.

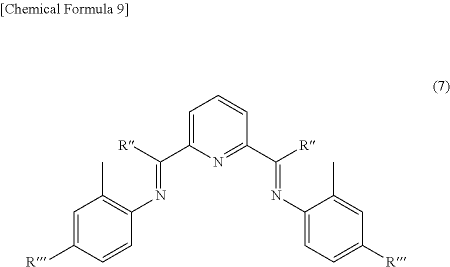

In the formula (7), R″ is a hydrocarbyl group having 1 to 6 carbon atoms or an aromatic group having 6 to 12 carbon atoms, a plurality of R″s in the same molecule may be the same or different, R′″ is a free radical having 0 to 6 carbon atoms and an oxygen atom and/or a nitrogen atom, and a plurality of R′″s in the same molecule may be the same or different.

According to the third production method, a catalytic efficiency can be increased and the polymerization activity can be maintained for an extended period of time in the oligomerization of a polymerizable monomer including an olefin.

Further, the present invention provides a catalyst containing an iron compound represented by the above formula (2) and a compound represented by the above formula (7) (hereinafter, conveniently referred to as “third catalyst”).

### Advantageous Effects of Invention

According to the present invention, an oligomer production method and a catalyst capable of, in the oligomerization of a polymerizable monomer including an olefin, efficiently growing an oligomer to be obtained to an intended molecular weight and sufficiently suppressing the progression of polymerization can be provided.

Further, according to the present invention, an oligomer production method and a catalyst capable of, in the copolymerization of a polymerizable monomer including ethylene and an α-olefin, obtaining a co-oligomer with good copolymerizability can be provided.

Further, according to the present invention, an oligomer production method and a catalyst capable of efficiently producing an oligomer having a narrow molecular weight distribution from a polymerizable monomer including an olefin can be provided.

Further, according to the present invention, an oligomer production method and a catalyst capable of, in the oligomerization of a polymerizable monomer including an olefin, increasing a catalytic efficiency and maintaining the polymerization activity for an extended period of time can be provided.

### DESCRIPTION OF EMBODIMENTS

Hereinafter, preferred embodiments of the present invention are described in detail.

[Catalyst (First Catalyst)]

The first catalyst for the co-oligomerization of a polymerizable monomer including ethylene and an α-olefin according to the present embodiment contains (A) a rac-ethylidene indenyl zirconium compound, (B) an iron compound, (C) methylaluminoxane and/or a boron compound and (D) an organozinc compound and/or an organoaluminum compound other than methylaluminoxane.

Hereinafter, each of the components is described.

<(A) Rac-Ethylidene Indenyl Zirconium Compound>

In the present embodiment, (A) rac-ethylidene indenyl zirconium compound is represented by the following formula (1).

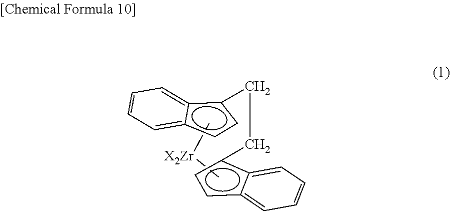

In the formula (1), X is a halogen atom, a hydrogen atom or a hydrocarbyl group having 1 to 6 carbon atoms. Examples of such a compound specifically include rac-ethylidene indenyl zirconium dichloride, rac-ethylidene indenyl zirconium dibromide, rac-ethylidene indenyl zirconium dihydride, rac-ethylidene indenyl zirconium hydride chloride and rac-ethylidene indenyl zirconium dimethyl. Among these, rac-ethylidene indenyl zirconium dichloride is preferable in light of the easy availability. These rac-ethylidene indenyl zirconium compounds can be used singly or in combination of two or more.

<(B) Iron Compound>

In the present embodiment, (B) iron compound is represented by the following formula (2).

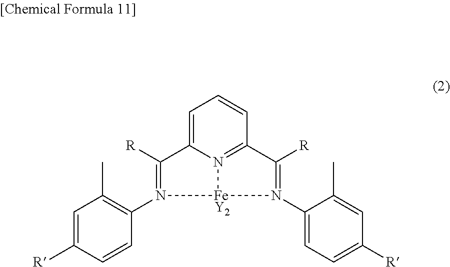

In the formula (2), R is a hydrocarbyl group having 1 to 6 carbon atoms or an aromatic group having 6 to 12 carbon atoms, and a plurality of R′s in the same molecule may be the same or different. Specific examples of R include a methyl group and a phenyl group. R′ is a free radical having 0 to 6 carbon atoms and an oxygen atom and/or a nitrogen atom, and a plurality of R′s in the same molecule may be the same or different. Specific examples of R′ include a hydrogen atom, a methoxy group, an ethoxy group, an isopropoxy group, a nitro group, a methyl group, an ethyl group, a propyl group, an isopropyl group, a butyl group, an isobutyl group, a tertiary butyl group, a hexyl group, a phenyl group and a cyclohexyl group. Y is a chlorine atom or a bromine atom. Examples of such a compound specifically include each of the compounds represented by the following formulae (2a) to (2h). These iron compounds can be used singly or in combination of two or more.

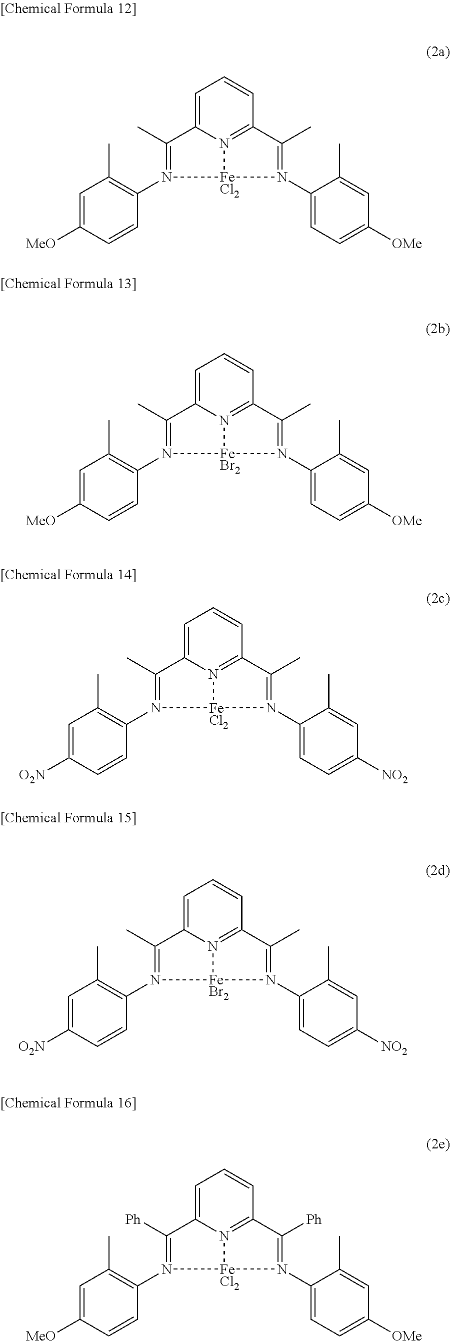

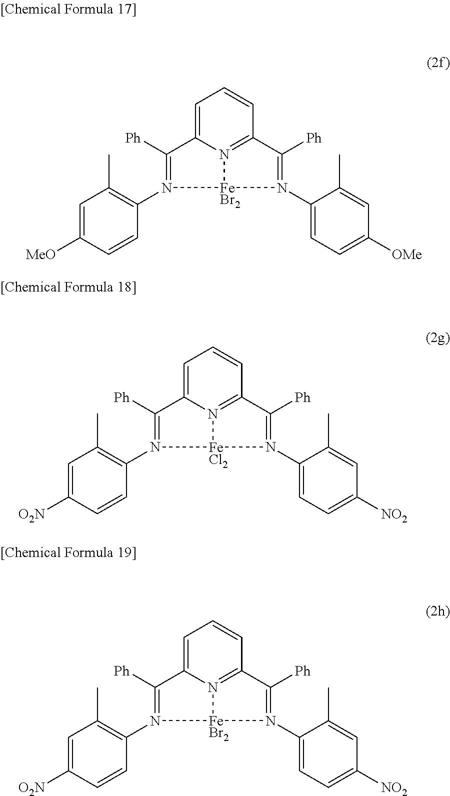

<(C) Methylaluminoxane, Boron Compound>

The first catalyst according to the present embodiment contains (C) methylaluminoxane and/or a boron compound.

For methylaluminoxane, a commercial product diluted with a solvent can be used and methylaluminoxane obtained by partial hydrolysis of trimethylaluminum in a solvent can also be used. When unreacted trimethylaluminum remains in such a methylaluminoxane, the unreacted trimethylaluminum may be used as the (D) component to be described later in detail or may be used as dried methylaluminoxane obtained by distilling trimethylaluminum and the solvent off under reduced pressure. Further, modified methylaluminoxane obtained by allowing trialkylaluminum other than trimethylaluminum such as triisobutylaluminum to coexist at the time of the partial hydrolysis of trimethylaluminum and co-hydrolyzing the resultant can also be used. When trialkylaluminum remains, similarly in this case, the unreacted trialkylaluminum may be used as the (D) component to be described later in detail or may be used as dried modified methylaluminoxane in which trialkylaluminum and the solvent are distilled off under reduced pressure.

Examples of the boron compound include aryl boron compounds such as trispentafluorophenylborane. Further, the boron compounds having anionic species can also be used as the boron compound. Examples include aryl borates such as tetrakispentafluorophenylborate and tetrakis(3,5-trifluoromethylphenyl)borate. Specific examples of the aryl borate include lithium tetrakispentafluorophenylborate, sodium tetrakispentafluorophenylborate, N,N-dimethylanilinium tetrakispentafluorophenylborate, trityl tetrakispentafluorophenylborate, lithium tetrakis(3,5-trifluoromethylphenyl)borate, sodium tetrakis(3,5-trifluoromethylphenyl)borate, N,N-dimethylanilinium tetrakis(3,5-trifluoromethylphenyl)borate and trityl tetrakis(3,5-trifluoromethylphenyl)borate. Among these, N,N-dimethylanilinium tetrakispentafluorophenylborate, trityl tetrakispentafluorophenylborate, N,N-dimethylanilinium tetrakis(3,5-trifluoromethylphenyl)borate and trityl tetrakis(3,5-trifluoromethylphenyl)borate are preferable. These boron compounds can be used singly or in combination of two or more.

<(D) Organozinc Compound, Organoaluminum Compound>

The first catalyst according to the present embodiment contains (D) an organozinc compound and/or an organoaluminum compound other than methylaluminoxane.

Specific examples of the organozinc compound include alkylzincs such as dimethylzinc and diethylzinc and arylzincs such as diphenylzinc. Alternatively, for the organozinc compound, a zinc halide such as zinc chloride, zinc bromide or zinc iodide may be allowed to act on alkyllithium, aryl Grignard, alkyl Grignard or the following organoaluminum compounds to form an organozinc compound in the reaction system. These organozinc compounds can be used singly or in combination of two or more.

Specific examples of the organoaluminum compound include trimethylaluminum, triethylaluminum, triisopropylaluminum, tripropylalumninum, tributylaluminum, triisobutylaluminum, trihexylaluminum, triphenylaluminum, diethylaluminum chloride, ethylaluminum dichloride and ethylaluminum sesquichloride. These organoaluminum compounds can be used singly or in combination of two or more.

It is preferable for the content ratio of the above (A) to (B) in the first catalyst to be, in a molar ratio, (A):(B)=1:5 to 5:1. When a content ratio of (A) to (B) is within the above range, the respective progression of homopolymerization of ethylene and an α-olefin can be notably suppressed thereby enabling the more efficient production of a co-oligomer.

Further, when the total number of moles of a content of (A) and (B) is Y, it is preferable for the content ratio of Y to (C) to be, in the case of using only methylaluminoxane as (C), Y:(C—Al)=1:10 to 1:1000, more preferable to be 1:20 to 1:500, in a molar ratio. When the total amount of (A) and (B) and the content ratio of (C—Al) are within the above ranges, factors of the increase in costs can be reduced while expressing the more sufficient polymerization activity. Note that (C—Al) represents the number of moles of the aluminum atom in methylaluminoxane.

To the contrary, when only the boron compound is used as (C), it is preferable that, in a molar ratio, Y:(C—B)=0.1:1 to 10:1, more preferable to be 0.5:1 to 2:1. When the total amount of (A) and (B) and the content ratio of (C—B) are within the above ranges, factors of the increase in costs can be reduced while expressing the more sufficient polymerization activity. Note that (C—B) represents the number of moles of the boron compound. When only the boron compound is used as (C), it is particularly preferable to use an alkyl complex as (A) and (B) or add an operation to convert to an alkyl complex. Examples of the method for converting to an alkyl complex include, in the case of conversion to a methyl complex, that (A) or (B) is allowed to contact an organoaluminum compound such as trimethylauminum, an organozinc compound such as dimethylzinc, an organolithium compound such as methyllithium or a Grignard compound such as methylmagnesium chloride, thereby being converted to a methyl complex of (A) or (B). Note that the organoaluminum compounds and the organozinc compounds listed herein may be those described in the above (D).

When methylaluminoxane and the boron compound are used in combination as (C), it is preferable that, in a molar ratio, Y:(C—Al)=1:1 to 1:100 and Y:(C—B)=1:1 to 1:10, more preferable that Y:(C—Al)=1:1 to 1:50 and Y:(C—B)=1:1 to 1:2. When the total amount of (A) and (B) and the content ratio of (C—Al) as well as the total amount of (A) and (B) and the content ratio of (C—B) are within the above ranges, factors of the increase in costs can be reduced while expressing the more sufficient polymerization activity. Further, the conversion to an alkyl complex of (A) and (B) described above can be carried out simultaneously.

Further, it is preferable for the content ratio of the above Y to (D) to be, in a molar ratio, Y:(D)=1:1 to 1:1000, more preferable to be 1:10 to 1:800. When the total amount of (A) and (B) and the content ratio of (D) are within the above ranges, the effect of chain transfer polymerization by the complexes (A) and (B) is notably demonstrated so that the respective progression of polymerization of ethylene and an α-olefin can be more notably suppressed and a co-oligomer having suitable copolymerizability and a molecular weight can be produced more efficiently. Note that the above content ratio of (D) represents, when an organoaluminum compound is used as (D), the number of moles of the aluminum atom in the organoaluminum compound.

[Method for Producing Oligomer (First Production Method)]

The first production method according to the present embodiment comprises a step of co-oligomerizing a polymerizable monomer including ethylene and an α-olefin in the presence of the above first catalyst.

Examples of the α-olefin used in the present embodiment include propylene, 1-butene, 1-pentene, 1-hexene, 1-octene, 1-decene and 1-dodecene, and additionally those having a branch such as a methyl group at a position other than the second position of the α-olefin such as 4-methyl-1-pentene. Among these α-olefins, it is preferable to use propylene in light of the reactivity.

The feed ratio of ethylene to an α-olefin for contacting the catalyst is not limited but it is preferable to be, in a molar ratio, ethylene:α-olefin=1000:1 to 1:1000, more preferable to be 100:1 to 1:100. Ethylene and α-olefins have different reactivities, so that the reactivity ratio can be calculated using Fineman-Ross method to suitably determine the feed ratio of ethylene and an α-olefin to be fed from the composition ratio of a desired product.

The polymerizable monomer used in the present embodiment may be those consisting of ethylene and an α-olefin or may further contain monomers other than ethylene and α-olefins. Further, examples of the method for introducing the polymerizable monomer to a reactor filled with the above catalyst include a method of introducing a polymerizable monomer mixture containing ethylene and an α-olefin and a method of continuously introducing monomer components such as ethylene and α-olefins.

In the first oligomer production method of the present embodiment, it is preferable for the reaction solvent to be a nonpolar solvent in light of carrying out the polymerization reaction satisfactorily. Examples of the nonpolar solvent include normal hexane, isohexane, heptane, octane, isooctane, cyclohexane, methylcyclohexane, benzene, toluene and xylene.

The reaction temperature in the present embodiment is not particularly limited but is preferably in the range of 0 to 100° C., more preferably in the range of 10 to 90° C., further preferably in the range of 20 to 80° C. When a reaction temperature is 0° C. or more, the reaction can be carried out efficiently without requiring a great amount of energy for cooling, whereas, when a reaction temperature is 100° C. or less, a decrease in activity of (B) the iron compound can be reduced. Furthermore, the reaction pressure is not particularly limited but is preferably 100 kPa to 5 MPa. The reaction time is not particularly limited but is preferably, for example, in the range of 1 minute to 24 hours.

The co-oligomer obtained by the above production method of the present embodiment does not only have good co-polymerizability but is further colorless and clear, and thus can be preferably used, for example, as a component for lubricating oil composition.

The “good co-polymerizability” used herein means that the molar ratio of ethylene/α-olefin in the polymer is within the range of, for example, 0.1 to 10.0, preferably within the range of 0.5 to 9.0. Note that examples of the measurement method of ethylene/α-olefin molar ratio in the polymer include a method in which ¹³C NMR is measured using a 600 MHz NMR apparatus to determine a molar ratio of ethylene to an α-olefin in the polymer from an integrated ratio of the α-olefin-derived peak and the ethylene-derived peak. For example, in the case of copolymerization of ethylene and propylene, a molar ratio in the co-oligomer can be calculated from the peak area derived from the methyl branch and the total peak area. A ratio of the ethylene chain and the propylene chain can be determined by a ¹³C NMR analysis but the random copolymerizability can be ascertained from the peak derived from such a homopolymerization and an oligomer with high random copolymerizability is colorless and clear.

The co-oligomer obtained by the above production method of the present embodiment has a number average molecular weight (Mn) within the range of, for example, 200 to 5000, preferably within the range of 300 to 4000. The dispersity is the ratio of a weight average molecular weight (Mw) to Mn, represented as Mw/Mn, and is preferably within the range of 1.0 to 5.0, more preferably within the range of 1.1 to 3.0. Note that the number average molecular weight (Mn) and the weight average molecular weight (Mw) of the co-oligomer can be determined, for example, in terms of polystyrene based on a calibration curve created from a standard polystyrene using a GPC apparatus.

[Catalyst (Second Catalyst)]

The second catalyst of the present embodiment contains a complex of a ligand being a diimine compound represented by the following formula (3) and at least one metal selected from the group consisting of Group 8 elements, Group 9 elements and Group 10 elements.

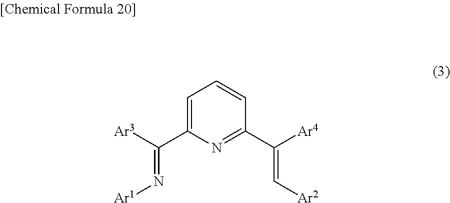

In the formula (3), Ar¹ and Ar² may be the same or different and are respectively a group represented by the following formula (4), and Ar³ and Ar⁴ may be the same or different and are respectively a group represented by the following formula (5).

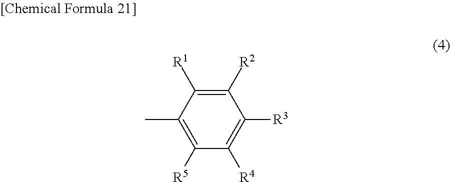

In the formula (4), R¹ and R⁵ may be the same or different and are respectively a hydrogen atom or a hydrocarbyl group having 1 to 5 carbon atoms, the total number of carbon atoms of R¹ and R⁵ is 1 or more and 5 or less, and R², R³ and R⁴ may be the same or different and are respectively a hydrogen atom or an electron-donating group.

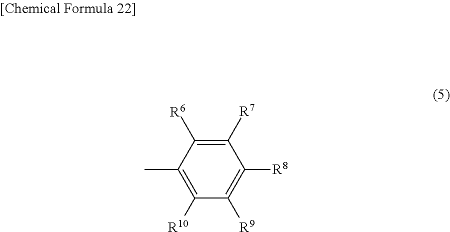

In the formula (5), R⁶ to R¹⁰ may be the same or different and are respectively a hydrogen atom or an electron-donating group.

Note that Ar¹ and Ar² in the same molecule may be the same or different but are preferably the same in light of simplifying the synthesis of the ligand.

Similarly, Ar³ and Ar⁴ in the same molecule may be the same or different but are preferably the same in light of simplifying the synthesis of the ligand.

Examples of the hydrocarbyl group having 1 to 5 carbon atoms and represented by R¹ and R⁵ include an alkyl group having 1 to 5 carbon atoms and an alkenyl group having 2 to 5 carbon atoms. The hydrocarbyl group may be linear, branched or cyclic. Further, the hydrocarbyl group may be a monovalent group of a linear or branched hydrocarbyl group bonded to a cyclic hydrocarbyl group.

Examples of the alkyl group having 1 to 5 carbon atoms include a linear alkyl group having 1 to 5 carbon atoms such as a methyl group, an ethyl group, an n-propyl group, an n-butyl group and an n-pentyl group; a branched alkyl group having 1 to 5 carbon atoms such as an iso-propyl group, an iso-butyl group, a sec-butyl group, a tert-butyl group and a branched pentyl group (including all structural isomers); and a cyclic alkyl group having 1 to 5 carbon atoms such as a cyclopropyl group and a cyclobutyl group.

Examples of the alkenyl group having 2 to 5 carbon atoms include a linear alkenyl group having 2 to 5 carbon atoms such as an ethenyl group (vinyl group), an n-propenyl group, an n-butenyl group and an n-pentenyl group; a branched alkenyl group having 2 to 5 carbon atoms such as an iso-propenyl group, an iso-butenyl group, a sec-butenyl group, a tert-butenyl group and a branched pentenyl group (including all structural isomers); and acyclic alkenyl group having 2 to 5 carbon atoms such as a cyclopropenyl group, a cyclobutenyl group and a cyclopentenyl group.

In light of controlling the molecular weight of an oligomer to be obtained by the catalytic activity and catalytic reaction of the second catalyst, the total number of carbon atoms of R¹ and R⁵ is 1 or more and 5 or less, preferably 1 or more and 4 or less, more preferably 1 or more and 3 or less, further preferably 1 or more and 2 or less, most preferably 1. Note that when the total number of carbon atoms of R¹ and R⁵ is 0 (in other words, when both R¹ and R⁵ are a hydrogen atom), the activity of the catalyst is insufficient. To the contrary, when the total number of carbon atoms of R¹ and R⁵ is 6 or more, the molecular conformation change hardly takes place due to the influence of steric hindrance by a substituent on the benzene ring. As a result, the elimination reaction is suppressed and the catalytic activity is lowered, and polymers having a large molecular weight are likely to be produced.

Further, in light of suppressing the influence of steric hindrance by a substituent on the benzene ring, it is preferable that either one of R¹ or R⁵ be a hydrogen atom and the other be a hydrocarbyl group having 1 to 5 carbon atoms.

In the formula (4), R², R³ and R⁴ are each independently a hydrogen atom or an electron-donating group. The electron-donating group is not particularly limited and examples include an alkyl group having 1 to 8 carbon atoms, an alkoxy group having 1 to 8 carbon atoms, an aryl group, an aryloxy group and a monovalent group of two or more of these groups combined. The alkyl group and the alkoxy group may be either of linear, branched or cyclic. Further, the aryl group and the aryloxy group may have a substituent such as an alkyl group.

Examples of R², R³ and R⁴ include specifically a methyl group, an ethyl group, a linear or branched propyl group, a linear or branched butyl group, a linear or branched pentyl group, a linear or branched hexyl group, a cyclohexyl group, a methylcyclohexyl group, a phenyl group, a tolyl group, a xylyl group, a hydroxy group, a methoxy group, an ethoxy group, a linear or branched propoxy group, a linear or branched butoxy group, a linear or branched pentyloxy group, a cyclopentyloxy group, a linear or branched hexyloxy group, a cyclohexyloxy group, a phenoxy group, a tolyloxy group and a xylyloxy group. Among these, a hydrogen atom, a methyl group and a methoxy group are preferable.

In the formula (5), R⁶ to R¹⁰ are each independently a hydrogen atom or an electron-donating group. Examples of the electron-donating group include those described above. Examples of the substituent represented by the formula (5) include, specifically, a phenyl group, an orthotolyl group, a metatolyl group, a paratolyl group, a 2,3-dimethylphenyl group, a 2,4-dimethylphenyl group, a 2,5-dimethylphenyl group, a 2,6-dimethylphenyl group, a 3,4-dimethylphenyl group, a 3,5-dimethylphenyl group an orthomethoxyphenyl group, a metamethoxyphenyl group, a paramethoxyphenyl group, an orthoethoxyphenyl group, a metaethoxyphenyl group, a paraethoxyphenyl group, an orthoisopropoxyphenyl group, a metaisopropoxyphenyl group, a paraisopropoxyphenyl group, an orthophenoxyphenyl group, a metaphenoxyphenyl group and a paraphenoxyphenyl group.

Examples of the preferable aspect of the diimine compound represented by the formula (3) include each of the diimine compounds represented by the following formulae (3-1) to (3-6). These can be used singly or in combination of two or more.

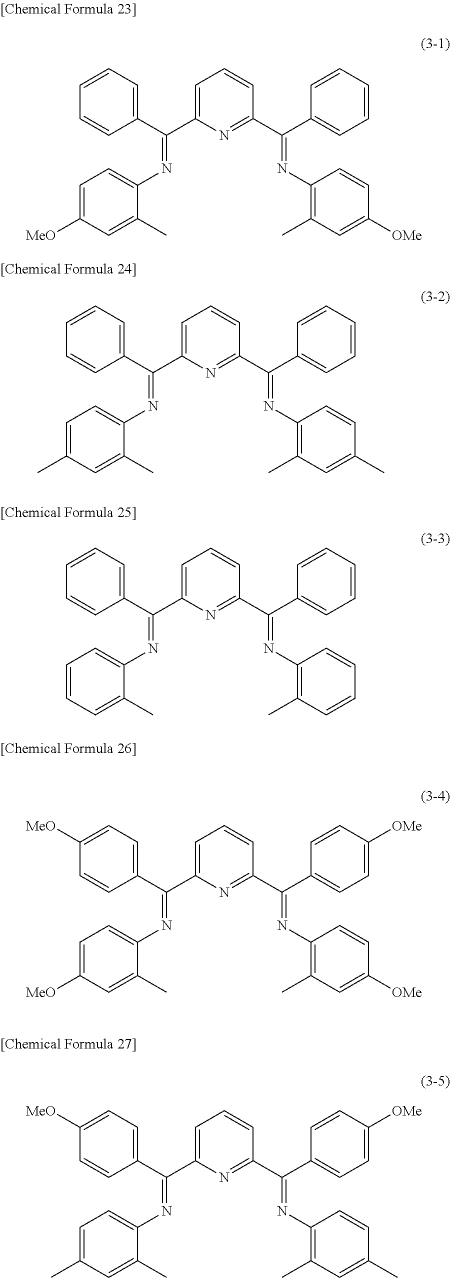

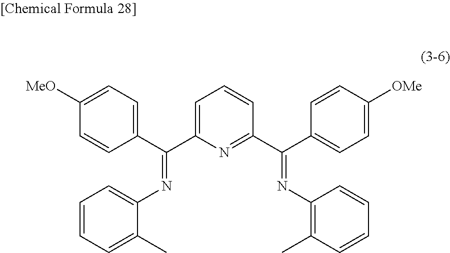 [SMILES: COc1ccc(/C(=N\c2ccccc2C)c2cccc(/C(=N/c3ccccc3C)c3ccc(OC)cc3)n2)cc1]

The diimine compound represented by the formula (3) can be synthesized by, for example, dehydrocondensing benzoylpyridine and an aniline compound in the presence of an acid.

A preferable aspect of the production method of the diimine compound represented by the formula (3) comprises a first step of dissolving 2,6-dibenzoylpyridine, an aniline compound and an acid in a solvent and dehydrocondensing by heating under reflux with the solvent and a step of carrying out separation and purification treatments of the reaction mixture after the first step to obtain the diimine compound represented by the formula (3).

The acid used in the first step can be, for example, an organoaluminum compound. Examples of the organoaluminum compound include trimethylaluminum, triethylaluminum, tripropylaluminum, triisopropylaluminum, tributylaluminum, triisobutylaluminum, trihexylaluminum, trioctylaluminum, diethylaluminum chloride, ethylaluminum chloride, ethylaluminum sesquichloride and methylaluminoxane.

The acid used in the first step can be a protic acid in addition to the above organoaluminum compounds. The protic acid is used as a proton-donating acid catalyst. The protic acid to be used is not particularly limited but is preferably an organic acid. Examples of such a protic acid include acetic acid, trifluoroacetic acid, methanesulfonic acid, trifluoromethanesulfonic acid and para-toluenesulfonic acid. When these protic acids are used, it is preferable to remove water using a Dean-Stark water separator. Alternatively, the reaction can also be carried out in the presence of an adsorbent such as molecular sieves. The amount of the protic acid to be added is not particularly limited and may be a catalytic amount.

Examples of the solvent used in the first step include hydrocarbon solvents and alcohol solvents. Examples of the hydrocarbon solvent include hexane, heptane, octane, benzene, toluene, xylene, cyclohexane and methylcyclohexane. Examples of the alcohol solvent include methanol, ethanol and isopropyl alcohol.

The reaction conditions for the first step can be suitably selected in accordance with the kind and amount of the raw material compounds, acid and solvent.

The separation and purification treatments in the second step is not particularly limited and examples include silica gel column chromatography and recrystallizing method. Particularly, when the organoaluminum compound described above is used as the acid, it is preferable to mix the reaction solution with a basic aqueous solution to decompose and remove the aluminum and subsequently purify.

The second catalyst according to the present embodiment contains, as the central metal of the complex, at least one metal selected from the group consisting of Group 8 elements, Group 9 elements and Group 10 elements. The “Group 8 elements”, “Group 9 elements” and “Group 10 elements” used herein are the names based on the IUPAC long periodic table (new periodic table). These elements may sometimes be collectively named as “Group VIII element” based on the short periodic table (old periodic table). More specifically, Group 8 elements, Group 9 elements and Group 10 elements (Group VIII element) are at least one selected from the group consisting of iron, cobalt, nickel, ruthenium, rhodium, palladium and platinum.

Among these elements, iron is preferable in light of high polymerization activity and availability.

In the production method of the second catalyst according to the present embodiment, the mixing method of the diimine compound represented by the formula (3) and at least one metal selected from the group consisting of Group 8 elements, Group 9 elements and Group 10 elements is not particularly limited and examples include (i) a method of adding at least one metal salt selected from the group consisting of Group 8 elements, Group 9 elements and Group 10 elements (hereinafter, sometimes simply referred to as “salt”) to a solution with the diimine compound dissolved therein and mixing, (ii) a method of mixing a solution with the diimine compound dissolved therein and a solution with the salt dissolved therein and (iii) a method of physically mixing the diimine compound and the salt without using a solvent.

The method for taking out the complex from the mixture of the diimine compound represented by the formula (3) and at least one metal selected from the group consisting of Group 8 elements, Group 9 elements and Group 10 elements is not particularly limited and examples include

(a) a method of distilling off a solvent when the solvent is used in the mixture, and separating the solid matter by filtration,
(b) a method of separating the precipitate produced from the mixture by filtration,
(c) a method of purifying the precipitate by adding a poor solvent to the mixture and separating by filtration and
(d) a method of directly taking out the solvent-free mixture.
Subsequently, washing treatment using a solvent capable of dissolving the diimine compound represented by formula (3), washing treatment using a solvent capable of dissolving the metal or recrystallization treatment using a suitable solvent may further be carried out.

Among the above methods, the method of dissolving the diimine compound and the salt using a solvent and mixing (in other words, the methods (i) and (ii)) can form the complex in the system and be directly used as the catalyst, eliminating the necessity of the operation for purifying the produced complex, hence industrially preferable. In other words, the mixtures of (i) and (ii) can also be used directly as the catalysts. Alternatively, it is also feasible to prepare the catalyst by separately adding to a reactor a solution (or a slurry) of the diimine compound represented by the formula (3) and a solution (or a slurry) of at least one metal selected from the group consisting of Group 8 elements, Group 9 elements and Group 10 elements.

Examples of the salt of at least one metal selected from the group consisting of Group 8 elements, Group 9 elements and Group 10 elements include iron(II) chloride, iron(III) chloride, iron(II) bromide, iron(III) bromide, iron(II) acetylacetonate, iron(III) acetylacetonate, iron(II) acetate, iron(III) acetate, cobalt(II) chloride, cobalt(III) chloride, cobalt(II) bromide, cobalt(III) bromide, cobalt(II) acetylacetonate, cobalt(III) acetylacetonate, cobalt(II) acetate, cobalt(III) acetate, nickel 2-ethylhexanoate, palladium chloride, palladium acetylacetonate and palladium acetate. These salts having a coordinated solvent or water may be used. Among these, the salt of iron(II) is preferable and iron(II) chloride is more preferable.

The solvent for allowing the diimine compound represented by the formula (3) to contact the metal is not particularly limited and both nonpolar solvents and polar solvents can be used. Examples of the nonpolar solvent include hydrocarbon solvents such as hexane, heptane, octane, benzene, toluene, xylene, cyclohexane and methylcyclohexane. Examples of the polar solvent include polar protic solvents such as alcohol solvents and polar aprotic solvents such as tetrahydrofuran. Examples of the alcohol solvent include methanol, ethanol and isopropyl alcohol. Particularly when the mixture is directly used as the catalyst, it is preferable to use a hydrocarbon solvent that substantially does not affect the olefin polymerization.

In the second catalyst according to the present embodiment, the content ratio of the diimine compound represented by the formula (3) and at least one metal selected from the group consisting of Group 8 elements, Group 9 elements and Group 10 elements is not particularly limited and the unreacted diimine compound and/or metal may be contained. The ratio of the diimine compound/metal is, in a molar ratio, preferably 0.2/1 to 5/1, more preferably 0.3/1 to 3/1, further preferably 0.5/1 to 2/1. When a ratio of the diimine compound/metal is 0.2/1 or more, the olefin polymerization reaction by the metal to which a ligand is not coordinated can be reduced, thus enabling an intended olefin polymerization reaction to progress selectively. When a ratio of the diimine compound/metal is 5/1 or less, the coordination and the like by excessive ligands is reduced, thus further increasing the activity of the olefin polymerization reaction.

It is preferable that two imine moieties in the diimine compound used as the raw material be both E form but when the diimine compound containing both moieties being the E form is contained, a diimine compound containing the Z form may be contained. Since the diimine compound containing the Z form does not easily form a complex with a metal, the compound can be easily removed during the purification step such as solvent washing after a complex is formed in the system.

The second catalyst according to the present embodiment can further contain an organoaluminum compound. The organoaluminum compound, in the olefin polymerization reaction, functions as a cocatalyst for further enhancing the catalytic activity of the above complex.

Specific examples of the organoaluminum compound include trimethylaluminum, triethylaluminum, tripropylaluminum, triisopropylaluminum, tributylaluminum, triisobutylaluminum, trihexylaluminum, trioctylaluminum, diethylaluminum chloride, ethylaluminum chloride, ethylaluminum sesquichloride and methylaluminoxane. These organoaluminum compounds can be used singly or in combination of two or more.

For methylaluminoxane, a commercial product diluted with a solvent can be used and those wherein trimethylaluminum is partially hydrolyzed in a solvent can also be used. Further, modified methylaluminoxane obtained by allowing trialkylaluminum other than trimethylaluminum such as triisobutylaluminum to coexist at the time of the partial hydrolysis of trimethylaluminum and be co-partially hydrolyzed can also be used. Further, when unreacted trialkylaluminum remains at the time of the above partial hydrolysis, the unreacted trialkylaluminum may be removed by distilling off under reduced pressure. Alternatively, modified methylaluminoxane obtained by modifying methylaluminoxane with an active protic compound such as phenol and derivatives thereof may also be used.

The content ratio of the organoaluminum compound in the second catalyst is not particularly limited. It is preferable for the ratio of the metal in the aluminum/complex in the organoaluminum compound to be, in a molar ratio, 1/1 to 5000/1. When a ratio of the metal in the aluminum/complex in the organoaluminum compound is 1/1 or more, the olefin polymerization reaction progresses more efficiently, whereas, when such a ratio is 5000/1 or less, the production cost can be reduced.

The second catalyst according to the present embodiment may further contain an organozinc compound or an organomagnesium compound in place of or together with the organoaluminum compound. Examples of the organozinc compound include diethylzinc and diphenylzinc. Examples of the organomagnesium compound include methylmagnesium chloride, methylmagnesium bromide, methylmagnesium iodide, ethylmagnesium chloride, ethylmagnesium bromide, ethylmagnesium iodide, (iso)propylmagnesium chloride, (iso)propylmagnesium bromide, (iso)propylmagnesium iodide, phenylmagnesium chloride, phenylmagnesium bromide and phenylmagnesium iodide. These can be used singly or in combination of two or more.

[Method for Producing Oligomer (Second Production Method)]

The second production method of the present embodiment comprises a step of oligomerizing a polymerizable monomer including an olefin in the presence of a catalyst containing a complex of the ligand being a diimine compound represented by the following formula (3) and at least one metal selected from the group consisting of Group 8 elements, Group 9 elements and Group 10 elements. Note that the catalyst of the present embodiment is the same as the second catalyst described above and the redundant explanation is left out herein.

Examples of the olefin include ethylene and α-olefins. Examples of the α-olefin encompasses, in addition to propylene, 1-butene, 1-pentene, 1-hexene, 1-octene, 1-decene, 1-dodecene, 1-tetradecene, 1-hexadecene and 1-octadecene, those having a branch such as a methyl group at a position other than the second position of the α-olefin such as 4-methyl-1-pentene.

The oligomer obtained by the second production method according to the present embodiment may be a homopolymer of one of the above olefins or a copolymer of two or more. It is preferable for the oligomer according to the present embodiment to be, in light of the reactivity, a homopolymer of ethylene or propylene or a copolymer of ethylene and propylene, more preferable to be a homopolymer of ethylene. Further, the oligomer may further contain a structural unit derived from a monomer other than the olefins.

One aspect of the second production method according to the present embodiment is a method for introducing the polymerizable monomer to a reactor filled with the catalyst. The introduction method of the polymerizable monomer to a reactor is not particularly limited and, when the polymerizable monomer is a monomer mixture containing two or more olefins, the monomer mixture may be introduced to a reactor or each of the polymerizable monomers may be introduced separately.

Further, a solvent may be used at the time of oligomerization. Examples of the solvent include aliphatic hydrocarbon solvents such as butane, pentane, hexane, heptane, octane, cyclohexane, methylcyclohexane and decalin; aromatic hydrocarbon solvents such as tetralin, benzene, toluene and xylene. The catalyst can be dissolved in these solvents to carry out solution polymerization or slurry polymerization. Bulk polymerization can also be carried out using the polymerizable monomer including an olefin as the solvent.

The reaction temperature for the oligomerization is not particularly limited but, for example, it is preferable to range of −20 to 100° C., more preferable to range of −10 to 90° C., further preferable to range of 0 to 80° C. When a reaction temperature is −20° C. or more, the deposition of the produced oligomer can be reduced, whereas, when a reaction temperature is 100° C. or less, the decomposition of the catalyst can be reduced. Furthermore, the reaction pressure is not particularly limited but it is preferable to be 100 kPa to 5 MPa. The reaction time is not particularly limited but it is preferable, for example, to range of 1 minute to 24 hours.

In the present embodiment, the “oligomer” means a polymer having a number average molecular weight (Mn) of 10000 or less. The number average molecular weight of the oligomer obtained by the above second production method can be suitably adjusted in accordance with the purpose of use. When the oligomer is used as a wax or a lubricating oil, for example, the Mn of the oligomer is preferably 300 to 8000, more preferably 400 to 7000. Further, those having an Mw/Mn, representing the degree of molecular weight distribution, of less than 2.0 are preferable.

The Mn and Mw of the oligomer can be determined, for example, in terms of polystyrene based on a calibration curve created from a standard polystyrene using a GPC apparatus.

According to the second production method according to the present embodiment, an oligomer having a narrow molecular weight distribution can be efficiently produced. Thus, the production method according to the present embodiment is useful as the production method of base materials for a lubricating oil such as olefin oligomer waxes, poly α-olefin (PAO).

[Catalyst (Third Catalyst)]

The third catalyst according to the present embodiment contains an iron compound represented by the following formula (2) (hereinafter, sometimes simply referred to as the iron compound) and a compound represented by the following formula (7) (hereinafter, sometimes referred to as the ligand).

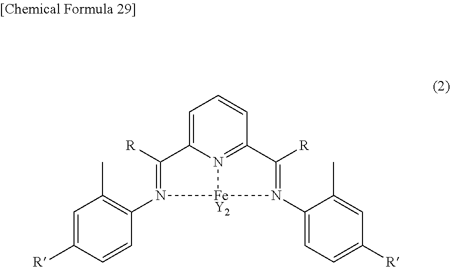

In the formula (2), R is a hydrocarbyl group having 1 to 6 carbon atoms or an aromatic group having 6 to 12 carbon atoms, a plurality of Rs in the same molecule may be the same or different, R′ is a free radical having 0 to 6 carbon atoms and an oxygen atom and/or a nitrogen atom, a plurality of R′s in the same molecule may be the same or different and Y is a chlorine atom or a bromine atom.

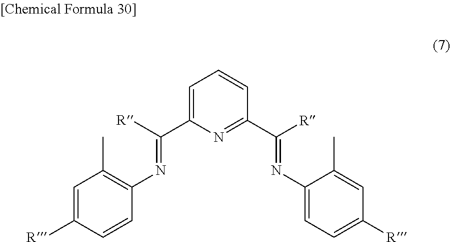

In the formula (7), R″ is a hydrocarbyl group having 1 to 6 carbon atoms or an aromatic group having 6 to 12 carbon atoms, a plurality of R″s in the same molecule may be the same or different, R′″ is a free radical having 0 to 6 carbon atoms and an oxygen atom and/or a nitrogen atom, and a plurality of R′″s in the same molecule may be the same or different.

In the formula (2), R and R′ in the same molecule may be the same or different but it is preferable to be same in light of simplifying the synthesis of the iron compound represented by the formula (2).

Examples of the hydrocarbyl group having 1 to 6 carbon atoms represented by R include an alkyl group having 1 to 6 carbon atoms and an alkenyl group having 2 to 6 carbon atoms. The hydrocarbyl group may be either of linear, branched or cyclic. Further, the hydrocarbyl group may be a monovalent group of a linear or branched hydrocarbyl group bonded to a cyclic hydrocarbyl group.

Examples of the alkyl group having 1 to 6 carbon atoms include a linear alkyl group having 1 to 6 carbon atoms such as a methyl group, an ethyl group, an n-propyl group, an n-butyl group, an n-pentyl group and an n-hexyl group; a branched alkyl group having 1 to 6 carbon atoms such as an iso-propyl group, an iso-butyl group, a sec-butyl group, a tert-butyl group, a branched pentyl group (including all structural isomers) and a branched hexyl group (including all structural isomers); and a cyclic alkyl group having 1 to 6 carbon atoms such as a cyclopropyl group, a cyclobutyl group, a cyclopentyl group and a cyclohexyl group.

Examples of the alkenyl group having 2 to 6 carbon atoms include a linear alkenyl group having 2 to 6 carbon atoms such as an ethenyl group (vinyl group), an n-propenyl group, an n-butenyl group, an n-pentenyl group and an n-hexenyl group; a branched alkenyl group having 2 to 6 carbon atoms such as an iso-propenyl group, an iso-butenyl group, a sec-butenyl group, a tert-butenyl group, a branched pentenyl group (including all structural isomers) and a branched hexenyl group (including all structural isomers); and a cyclic alkenyl group having 2 to 6 carbon atoms such as a cyclopropenyl group, a cyclobutenyl group, a cyclopentenyl group, a cyclopentadienyl group, a cyclohexenyl group and a cyclohexadienyl group.

Examples of the aromatic group having 6 to 12 carbon atoms represented by R include a phenyl group, a tolyl group, a xylyl group and a naphthyl group.

Examples of the free radical having 0 to 6 carbon atoms and an oxygen atom and/or a nitrogen atom represented by R′ include a methoxy group, an ethoxy group, an isopropoxy group and a nitro group.

Example of such an iron compound specifically include each of the iron compounds represented by the following formulae (2a) to (2h). These iron compounds can be used singly or in combination of two or more.

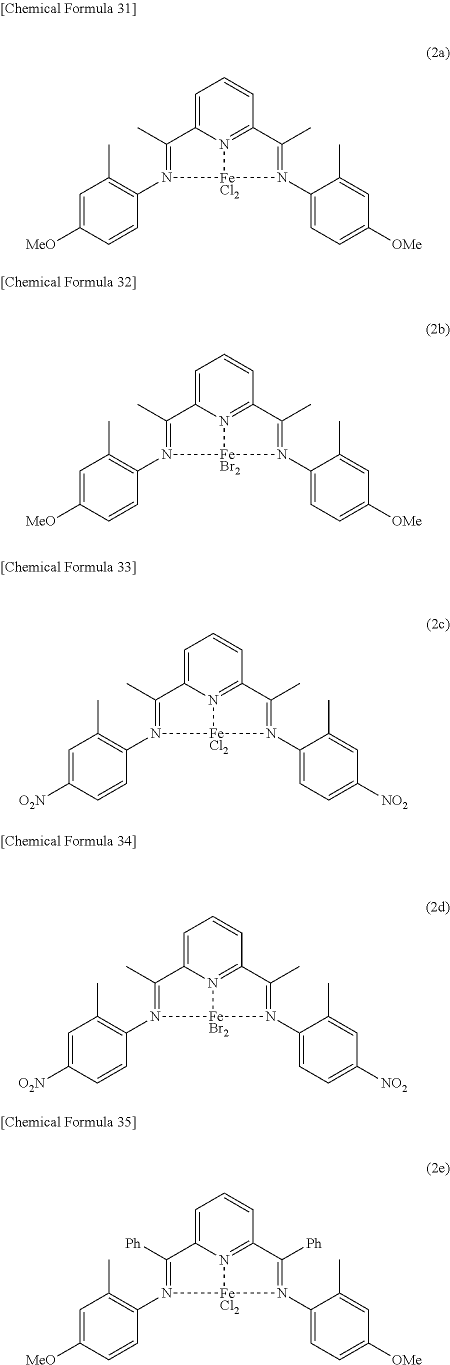

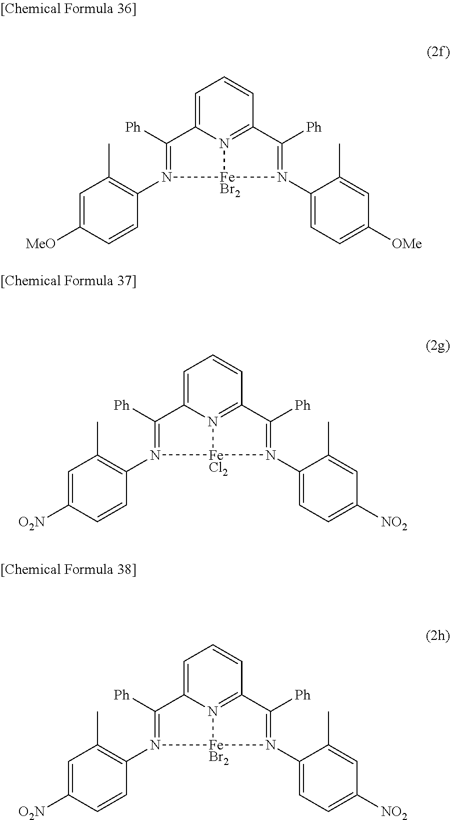

In the formula (7), R″ and R′″ in the same molecule may be the same or different but it is preferable to be same in light of simplifying the synthesis of the compound represented by the formula (7).

Examples of the alkyl group having 1 to 6 carbon atoms include a linear alkyl group having 1 to 6 carbon atoms such as a methyl group, an ethyl group, an n-propyl group, an n-butyl group, an n-pentyl group and an n-hexyl group; a branched alkyl group having 1 to 6 carbon atoms such as an iso-propyl group, an iso-butyl group, a sec-butyl group, a tert-butyl group and a branched pentyl group (including all structural isomers); and a cyclic alkyl group having 1 to 6 carbon atoms such as a cyclopropyl group, a cyclobutyl group, a cyclopentyl group and a cyclohexyl group.

Examples of the alkenyl group having 2 to 6 carbon atoms include a linear alkenyl group having 2 to 6 carbon atoms such as an ethenyl group (vinyl group), an n-propenyl group, an n-butenyl group, an n-pentenyl group and an n-hexenyl group; a branched alkenyl group having 2 to 6 carbon atoms such as an iso-propenyl group, an iso-butenyl group, a sec-butenyl group, a tert-butenyl group, a branched pentenyl group (including all structural isomers) and a branched hexenyl group (including all structural isomers); and a cyclic alkenyl group having 2 to 6 carbon atoms such as a cyclopropenyl group, a cyclobutenyl group, a cyclopentenyl group, a cyclopentadienyl group, a cyclohexenyl group and a cyclohexadienyl group.

Examples of the aromatic group having 6 to 12 carbon atoms represented by R include a phenyl group, a tolyl group, a xylyl group and a naphthyl group.

Examples of the free radical having 0 to 6 carbon atoms and an oxygen atom and/or a nitrogen atom represented by R′ include a methoxy group, an ethoxy group, an isopropoxy group and a nitro group.

Examples of such a ligand specifically include each of the ligands represented by the following formulae (7a) to (7d). These ligands can be used singly or in combination of two or more.

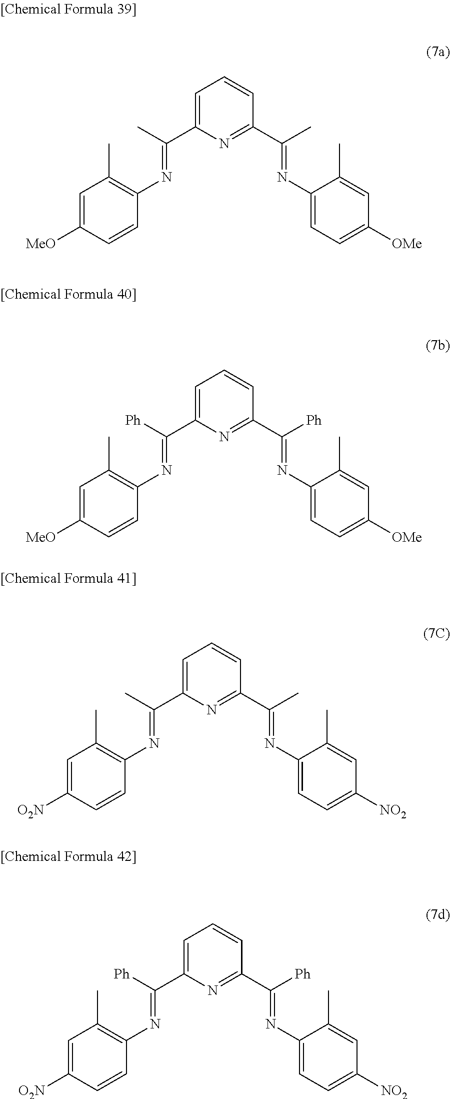 [SMILES: COc1ccc(/N=C(\C)c2cccc(/C(C)=N/c3ccc(OC)cc3C)n2)c(C)c1 ; COc1ccc(/N=C(\c2ccccc2)c2cccc(/C(=N/c3ccc(OC)cc3C)c3ccccc3)n2)c(C)c1 ; C/C(=N\c1ccc([N+](=O)[O-])cc1C)c1cccc(/C(C)=N/c2ccc([N+](=O)[O-])cc2C)n1 ; Cc1cc([N+](=O)[O-])ccc1/N=C(\c1ccccc1)c1cccc(/C(=N/c2ccc([N+](=O)[O-])cc2C)c2ccccc2)n1]

In the iron compound represented by the above formula (2) and the compound represented by the above formula (7) contained in the catalyst according to the present embodiment, R of the formula (2) and R″ of the formula (7), and R′ of the formula (2) and R′″ of the formula (7), may be the same or different but it is preferable to be same in light of maintaining the performance similar to the iron compound represented by the formula (2).

In the iron compound represented by the formula (2), the diimine compound constituting the ligand (hereinafter, sometimes simply referred to as the diimine compound) can be synthesized by, for example, dehydrocondensing benzoylpyridine and an aniline compound in the presence of an acid.

A preferable aspect of the production method of the above diimine compound comprises a first step of dissolving 2,6-dibenzoylpyridine, an aniline compound and an acid in a solvent and dehydrocondensing by heating under reflux with the solvent, and a step of carrying out separation and purification treatments of the reaction mixture after the first step to obtain the diimine compound.

The acid used in the first step can be, for example, an organoaluminum compound. Examples of the organoaluminum compound include trimethylaluminum, triethylaluminum, tripropylaluminum, triisopropylaluminum, tributylaluminum, triisobutylaluminum, trihexylaluminum, trioctylaluminum, diethylaluminum chloride, ethylaluminum chloride, ethylaluminum sesquichloride and methylaluminoxane.

The acid used in the first step can be a protic acid in addition to the above organoaluminum compounds. The protic acid is used as a proton-donating acid catalyst. The protic acid to be used is not particularly limited but is preferably an organic acid. Examples of such a protic acid include acetic acid, trifluoroacetic acid, methanesulfonic acid, trifluoromethanesulfonic acid and para-toluenesulfonic acid. When these protic acids are used, it is preferable to remove water using a Dean-Stark water separator. Alternatively, the reaction can also be carried out in the presence of an adsorbent such as molecular sieves. The amount of the protic acid to be added is not particularly limited and may be a catalytic amount.

Examples of the solvent used in the first step include hydrocarbon solvents and alcohol solvents. Examples of the hydrocarbon solvent include hexane, heptane, octane, benzene, toluene, xylene, cyclohexane and methylcyclohexane. Examples of the alcohol solvent include methanol, ethanol and isopropyl alcohol.

The reaction conditions for the first step can be suitably selected in accordance with the kind and amount of the raw material compounds, acid and solvent.

The separation and purification treatments of the second step is not particularly limited and examples include silica gel column chromatography and recrystallizing method. Particularly, when the organoaluminum compound described above is used as the acid, it is preferable to mix the reaction solution with a basic aqueous solution to decompose and remove the aluminum and subsequently purify.

The iron compound according to the present embodiment contains iron as the central metal. The mixing method of the above diimine compound and the iron is not particularly limited and examples include

(i) a method of adding a salt of the iron (hereinafter, sometimes simply referred to as the “salt”) to a solution with the diimine compound dissolved therein and mixing,
(ii) a method of mixing a solution with the diimine compound dissolved therein and a solution with the salt dissolved therein and
(iii) a method of physically mixing the diimine compound and the salt without using a solvent.

The method for taking out the complex from the mixture of the diimine compound and the iron is not particularly limited and examples include

(a) a method of distilling off a solvent when the solvent is used in the mixture, and separating the solid matter by filtration,
(b) a method of separating the precipitate produced from the mixture by filtration,
(c) a method of purifying the precipitate by adding a poor solvent to the mixture and separating by filtration, and
(d) a method of directly taking out the solvent-free mixture.
Subsequently, washing treatment using a solvent capable of dissolving the diimine compound, washing treatment using a solvent capable of dissolving the metal or recrystallization treatment using a suitable solvent may further be carried out.

Examples of the salt of irons include iron(II) chloride, iron(III) chloride, iron(II) bromide, iron(III) bromide, iron(II) acetylacetonate, iron(III) acetylacetonate, iron(II) acetate and iron(III) acetate. These salts having a coordinated solvent or water may be used. Among these, the salt of iron(II) is preferable and of iron(II) chloride is more preferable.

The solvent for allowing the diimine compound to contact the iron is not particularly limited and both nonpolar solvents and polar solvents can be used. Examples of the nonpolar solvent include hydrocarbon solvents such as hexane, heptane, octane, benzene, toluene, xylene, cyclohexane and methylcyclohexane. Examples of the polar solvent include polar protic solvents such as alcohol solvents and polar aprotic solvent such as tetrahydrofuran. Examples of the alcohol solvent include methanol, ethanol and isopropyl alcohol. Particularly, when the mixture is directly used as the catalyst, it is preferable to use a hydrocarbon solvent that substantially does not affect the olefin polymerization.

Furthermore, the mixing ratio of the diimine compound and the iron when both are brought into contact with each other is not particularly limited. The ratio of the diimine compound/iron is, in a molar ratio, preferably 0.2/1 to 5/1, more preferably 0.3/1 to 3/1, further preferably 0.5/1 to 2/1, and particularly preferably 1:1.

It is preferable that two imine moieties in the diimine compound be both E form but when the diimine compound containing both moieties being the E form is contained, a diimine compound containing the Z form may be contained. Since the diimine compound containing the Z form does not easily form a complex with a metal, the compound can be easily removed during the purification step such as solvent washing after a complex is formed.

In the third catalyst according to the present embodiment, the content ratio of the iron compound to the ligand is not particularly limited. The ligand/iron compound ratio is, in a molar ration, preferably 1/100 to 100/1, more preferably 1/20 to 50/1, further preferably 1/10 to 10/1, particularly preferably 1/5 to 5/1, extremely preferably 1/3 to 3/1. When a ligand/iron compound ratio is 1/100 or more, the addition effect of the ligand can be fully demonstrated, whereas, when such a ratio is 100/1 or less, an increase in costs can be reduced while fully demonstrating the addition effect of the ligand.

The third catalyst according to the present embodiment can further contain at least one activator selected from the group consisting of organoaluminum compounds and boron compounds. The above activator, in the olefin polymerization reaction, functions as a cocatalyst for further enhancing the catalytic activity of the above complex.

Specific examples of the organoaluminum compound include trimethylaluminum, triethylaluminum, tripropylaluminum, triisopropylaluminum, tributylaluminum, triisobutylaluminum, trihexylaluminum, trioctylaluminum, diethylaluminum chloride, ethylaluminum chloride, ethylaluminum sesquichloride and methylaluminoxane. These organoaluminum compounds can be used singly or in combination of two or more.

For methylaluminoxane, a commercial product diluted with a solvent can be used and those wherein trimethylaluminum is partially hydrolyzed in a solvent can also be used. Further, modified methylaluminoxane obtained by allowing trialkylaluminum other than trimethylaluminum such as triisobutylaluminum to coexist at the time of the partial hydrolysis of trimethylaluminum and be co-partially hydrolyzed can also be used. Further, when unreacted trialkylaluminum remains at the time of the above partial hydrolysis, the unreacted trialkylaluminum may be removed by distilling off under reduced pressure. Alternatively, modified methylaluminoxane obtained by modifying methylaluminoxane with an active protic compound such as phenol and derivatives thereof may be used.

Examples of the boron compound include aryl boron compounds such as trispentafluorophenylborane. Further, the boron compounds having anionic species can also be used as the boron compound. Examples include aryl borates such as tetrakispentafluorophenylborate and tetrakis(3,5-trifluoromethylphenyl)borate. Specific examples of the aryl borate include lithium tetrakispentafluorophenylborate, sodium tetrakispentafluorophenylborate, N,N-dimethylanilinium tetrakispentafluorophenylborate, trityl tetrakispentafluorophenylborate, lithium tetrakis(3,5-trifluoromethylphenyl)borate, sodium tetrakis(3,5-trifluoromethylphenyl)borate, N,N-dimethylanilinium tetrakis(3,5-trifluoromethylphenyl)borate and trityl tetrakis(3,5-trifluoromethylphenyl)borate. Among these, N,N-dimethylanilinium tetrakispentafluorophenylborate, trityl tetrakispentafluorophenylborate, N,N-dimethylanilinium tetrakis(3,5-trifluoromethylphenyl)borate or trityl tetrakis(3,5-trifluoromethylphenyl)borate is preferable. These boron compounds can be used singly or in combination of two or more.

When only the organoaluminum compound is used as the activator, it is preferable, when the number of moles of the iron compound represented by the formula (2) is G and the number of moles of the aluminum atom of the organoaluminum compound is H, for the content ratio of G to H to be, in a molar ratio, G:H=1:10 to 1:1000, more preferable to be 1:20 to 1:500. When the content ratio is within the above ranges, factors of the increase in costs can be reduced while expressing the more sufficient polymerization activity.

To the contrary, when only the boron compound is used as the activator, it is preferable, when the number of moles of the boron compound is J, for the content ratio of G to J to be, in a molar ratio, G:J=0.1:1 to 10:1, more preferable to be 0.5:1 to 2:1. When the content ratio is within the above range, factors of the increase in costs can be reduced while expressing the more sufficient polymerization activity. Note that when only the boron compound is used as the activator, particularly, it is preferable to add an operation to convert the iron compound represented by the formula (2) to an alkyl complex. Examples of the method for converting to an alkyl complex include, in the case of conversion to a methyl complex, that the iron compound represented by the formula (2) is allowed to contact an organoaluminum compound such as trimethylaluminum, an organozinc compound such as dimethylzinc, an organolithium compound such as methyllithium or a Grignard compound such as methylmagnesium chloride thereby being converted to a methyl complex. Note that as the organoaluminum compounds and the organozinc compounds listed herein, those described in (D) of the above first catalyst may be used.

When the organoaluminum compound and the boron compound are used in combination as the activator, it is preferable that, in a molar ratio, G:H=1:1 to 1:100 and G:J=1:1 to 1:10, more preferable to be G:H=1:1 to 1:50 and G:J=1:1 to 1:2. When the ratio is within the above ranges, factors of the increase in costs can be reduced while expressing the more sufficient polymerization activity. Further, the conversion to an alkyl complex of the iron compound represented by the formula (2) described above can also be carried out simultaneously.

In the third catalyst of the present embodiment, the production method of the catalyst containing the above activator is not particularly limited and the catalyst can be obtained by allowing the iron compound, the ligand and the activator described above to contact each other in any sequence. For example, a method of adding a solution containing the activator to a solution containing the iron compound and the ligand and mixing, and a method of adding a solution containing the ligand to a solution containing the iron compound and the activator and mixing.

The third catalyst of the present embodiment has been described so far but is not limited to the aspects described above. For example, as the third catalyst according to the present embodiment, a complex containing a metal other than iron in place of or together with the iron compound may also be used. Examples of the metal other than iron include cobalt. Examples of the complex containing cobalt include the cobalt compound represented by the following formula (8).

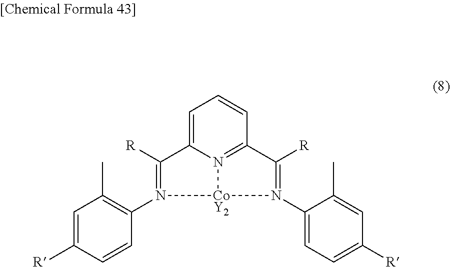

In the formula (8), R is a hydrocarbyl group having 1 to 6 carbon atoms or an aromatic group having 6 to 12 carbon atoms, a plurality of Rs in the same molecule may be the same or different, R′ is a free radical having 0 to 6 carbon atoms and an oxygen atom and/or a nitrogen atom, a plurality of R′s in the same molecule may be the same or different and Y is a chlorine atom or a bromine atom.

[Method for Producing Oligomer (Third Production Method)]

The third production method of the present embodiment comprises a step of oligomerizing a polymerizable monomer including an olefin in the presence of a catalyst containing an iron compound represented by the formula (2) and a compound represented by the formula (7). Note that the catalyst of the present embodiment is the same as the third catalyst described above and the redundant explanation is left out herein.

Examples of the olefin include ethylene and α-olefins. Examples of the α-olefin encompass, in addition to propylene, 1-butene, 1-pentene, 1-hexene, 1-octene, 1-decene, 1-dodecene, 1-tetradecene, 1-hexadecene and 1-octadecene, those having a branch such as a methyl group at a position other than the second position of the α-olefin such as 4-methyl-1-pentene.

The oligomer obtained by the third production method according to the present embodiment may be a homopolymer of one of the above olefins or a copolymer of two or more olefins. The oligomer according to the present embodiment may be a homopolymer of ethylene or propylene, a copolymer of ethylene and propylene or a homopolymer of ethylene. Further, the oligomer may contain a structural unit derived from a monomer other than the olefins.

One aspect of the third production method according to the present embodiment is a method for introducing the polymerizable monomer to a reactor filled with the catalyst. The introduction method of the polymerizable monomer to a reactor is not particularly limited and, when the polymerizable monomer is a monomer mixture containing two or more olefins, the monomer mixture may be introduced to a reactor or each of the polymerizable monomers may be introduced separately.

Further, a solvent may be used at the time of oligomerization. Examples of the solvent include aliphatic hydrocarbon solvents such as butane, pentane, hexane, heptane, octane, cyclohexane, methylcyclohexane and decalin; aromatic hydrocarbon solvents such as tetralin, benzene, toluene and xylene. The catalyst can be dissolved in these solvents and solution to carry out polymerization or slurry polymerization. Bulk polymerization can also be carried out using the polymerizable monomer including an olefin as the solvent.

The reaction temperature for the oligomerization is not particularly limited but, for example, it is preferable to range of −20 to 100° C., more preferable to range of −10 to 90° C., further preferable to range of 0 to 80° C. When a reaction temperature is −20° C. or more, the deposition of the produced oligomer can be reduced, whereas, when a reaction temperature is 100° C. or less, the decomposition of the catalyst can be reduced. Furthermore, the reaction pressure is not also particularly limited but it is preferable to be 100 kPa to 5 MPa. The reaction time is not particularly limited but it is preferable, for example, to range of 1 minute to 24 hours.

In the present embodiment, the “oligomer” means a polymer having a number average molecular weight (Mn) of 10000 or less. The number average molecular weight of the oligomer to be obtained by the above the third production method can be suitably adjusted in accordance with the purpose of use. When the oligomer is used as a wax or a lubricating oil, for example, the Mn of the oligomer is preferably 300 to 8000, more preferably 350 to 7000, further preferably 400 to 6000, particularly preferably 450 to 5000. Further, those having an Mw/Mn, representing the degree of molecular weight distribution, of less than 3.0 are preferable.

The Mn and Mw of the oligomer can be determined, for example, in terms of polystyrene based on a calibration curve created from a standard polystyrene using a GPC apparatus.

According to the third production method according to the present embodiment, a catalytic efficiency can be increased and the polymerization activity can be maintained for an extended period of time in the oligomerization of a polymerizable monomer including an olefin.

### EXAMPLES

Hereinafter, the present invention is illustrated with reference to Examples, but the following Examples do not intend to limit the present invention.

<First Catalyst Production and Co-Oligomer Production>

### [Preparation of Ingredients]

rac-Ethylidenebisindenylzirconium chloride purchased from Wako Pure Chemical Industries, Ltd. was used as it was. The iron compound was synthesized by the method illustrated in the synthesis examples described later. Commercially purchased reagents were used as they were during the synthesis. Triisobutylaluminum, a product of Nippon Aluminum Alkyls, Ltd., was diluted with dry toluene and used. Diethylzinc, a toluene solution of Tokyo Chemical Industry Co., Ltd., was used as it was. Methylaluminoxane, a product of Tosoh Finechem Corporation, TMAO-341, was used as it was. Trityl tetrakispentafluorophenylborate, a product of Tokyo Chemical Industry Co., Ltd. was used as it was.

For ethylene and propylene, high purity liquefied ethylene and liquefied propylene, products of Sumitomo Seika Chemicals, Co., Ltd., dried through molecular sieve 4A were used.

For toluene as the solvent, dehydrated toluene, a product of Aldrich, was used as it was.

[Measurement of the Molar Ratio of Ethylene to Propylene in a Polymer]

¹³C NMR was measured using a 600 MHz NMR apparatus (a product of Agilent, DD2) by quantitative mode with a relaxation time of 10 seconds to define the peak at 19 to 22 PPM as the methyl branch derived from propylene. The total carbon was defined as the peak appeared at 10 to 50 PPM and the molar ratio of ethylene to propylene in an oligomer was determined from the integrated ratio thereof. Note that the solvent was CDCl₃.

[Measurement of the Number Average Molecular Weight (Mn) and the Weight Average Molecular Weight (Mw)]

The measurement was carried out using a GPC apparatus (a product of Tosoh Corporation, HLC-8220GPC), to which two columns, TSKgel Super Multipore HZ-M, were connected, with tetrahydrofuran used as an eluent, a flow rate set to be 1 ml/min and a column oven temperature at 40° C. The molecular weight conversion was carried out based on a calibration curve prepared from a standard polystyrene and a molecular weight in terms of polystyrene was determined.

[Catalytic Efficiency Calculation]

The catalytic efficiency was calculated by dividing the weight of the obtained oligomer by the total number of moles of the catalyst fed.

[Synthesis of Diimine Product (I)]

2-Methyl-4-nitroaniline (1.048 g, 6.9 mmol) (a product of Tokyo Chemical Industry Co., Ltd.), 2,6-diacetylpyridine (0.5618 g, 3.5 mmol) (a product of Tokyo Chemical Industry Co., Ltd.) and a catalytic amount of para-toluenesulfonic acid were dispersed in dry xylene (60 ml) and stirred by heating under reflux for 24 hours while removing water using a Dean-Stark water separator. As heating was initiated, the dispersion was readily dissolved and formed a homogeneous solution.

The reaction solution was cooled. The precipitate was filtered. The obtained toluene solution was washed with saturated sodium bicarbonate solution and brine. The washed toluene solution was dried over anhydrous magnesium sulfate. Magnesium sulfate was separated by filtration and toluene was evaporated under reduced pressure to deposit the solid. The obtained solid was washed with ethanol to obtain the following diimine product (I) in a yield of 30%.

¹H-NMR (600 MHz, CDCl₃): 2.2 (s, 6H), 2.3 (s, 6H), 6.8 (m, 2H), 8.0 (m, 11H), 8.1 (m, 4H), 8.4 (m, 2H)

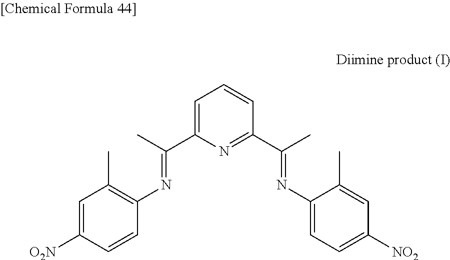 [SMILES: C/C(=N\c1ccc([N+](=O)[O-])cc1C)c1cccc(/C(C)=N/c2ccc([N+](=O)[O-])cc2C)n1]

[Synthesis of Iron Complex (I)]

FeCl₂*4H₂O (38 mg, 0.19 mmol) (a product of Kanto Chemical Co., Inc.) was dissolved in dry tetrahydrofuran (6 ml) (a product of Aldrich). A solution of the diimine product (I) (83 mg, 0.19 mmol) in tetrahydrofuran (5 ml) was added to the solution. By adding the yellow diimine, the tetrahydrofuran solution instantaneously turned to dark green. Further, the solution was stirred at room temperature for 2 hours. The solvent was evaporated from the reaction mixture. The resultant solid was continuously washed with dry ethanol until the filtrate had no color. The washed solid was further washed with dry diethyl ether. The remained solvent was evaporated to obtain an iron complex. The obtained iron complex had an ESI-MASS of 557.0316 (calculated value: 557.0321) suggesting the structure of the following iron complex (I).

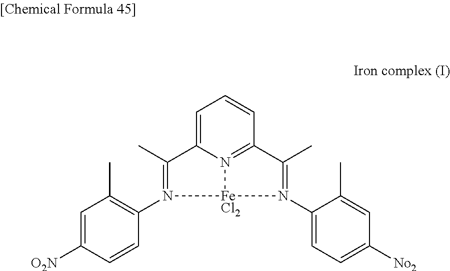

[Synthesis of Diimine Product (II)]

2-Methyl-4-methoxyaniline (2.0893 g, 15.3 mmol) (a product of Tokyo Chemical Industry Co., Ltd.), 2,6-diacetylpyridine (1.2429 g, 7.6 mmol) (a product of Tokyo Chemical Industry Co., Ltd.), molecular sieve 4A (5.0 g) and a catalytic amount of para-toluenesulfonic acid were dispersed in dry toluene (60 ml) and stirred by heating under reflux for 24 hours while removing water using a Dean-Stark water separator.

The molecular sieve was removed from the reaction solution by filtration and washed with toluene. Then washing solution and the filtered reaction solution were combined. The solution was evaporated to obtain a crude solid (2.8241 g). The crude solid obtained herein was weighed (2 g) and washed with dry ethanol (30 ml). The solid insoluble in ethanol was separated by filtration and the obtained insoluble solid was further washed with ethanol. The remained solid was thoroughly dried, thereby obtaining the following diimine product (II) in a yield of 50%.

¹H NMR (600 MHz, CDCl₃): 2.1 (s, 6H), 2.4 (s, 6H), 3.8 (s, 6H), 6.6 (m, 2H), 6.7 (m, 2H), 6.8 (m, 2H), 7.9 (m, 1H), 8.4 (m, 2H)

¹³C-NMR (600 MHz, CDCl₃): 16, 18, 56, 116, 119, 122, 125, 129, 137, 138, 143, 156, 167

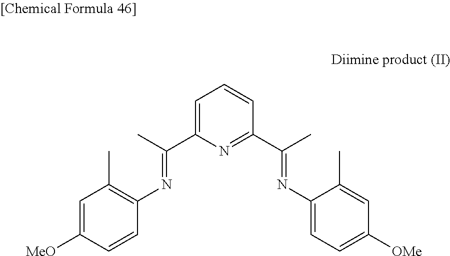 [SMILES: COc1ccc(/N=C(\C)c2cccc(/C(C)=N/c3ccc(OC)cc3C)n2)c(C)c1]

[Synthesis of Iron Complex (II)]

FeCl₂*4H₂O (0.2401 g, 1.2 mmol) (a product of Kanto Chemical Co., Inc.) was dissolved in dehydrated tetrahydrofuran (30 ml) (a product of Aldrich) and a solution of the diimine product (II) (0.4843 g, 1.2 mmol) in tetrahydrofuran (10 ml) was added thereto. By adding the yellow diimine, the tetrahydrofuran solution instantaneously turned to dark green. Further, the solution was stirred at room temperature for 2 hours. The solvent was evaporated from the reaction mixture. The resultant solid was continuously washed with dry ethanol until the filtrate had no color. The washed solid was further washed with dry diethyl ether. The remained solvent was evaporated to obtain an iron complex. The obtained iron complex had an FD-MASS of 527.0820 (calculated value: 527.0831) suggesting the structure of the following iron complex (II).

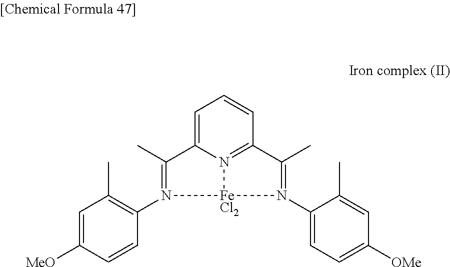

### Example 1

A 660 ml autoclave equipped with an electromagnetic stirrer was thoroughly dried at 110° C. under reduced pressure in advance. Dry toluene (30 ml), a solution of triisobutylaluminum in toluene (1M solution, 1.4 mmol in terms of Al) and a solution of diethylzinc in toluene (2.7 mmol) were introduced thereto under nitrogen.

Under nitrogen, rac-ethylidenebisindenylzirconium dichloride (12 μmol), the iron complex (I) (25 μmol), and 20 ml of dry toluene were introduced to a 50 ml eggplant flask. Methylaluminoxane (0.27 mmol in terms of Al) was added to the toluene solution and trityl tetrakispentafluorophenylborate (37 μmol) was further added thereto. The obtained solution was introduced into the autoclave with a temperature adjusted to 60° C. in a water bath to prepare the first catalyst.

A 2-L autoclave thoroughly dried in advance was charged with propylene (0.6 MPa), ethylene (0.3 MPa) was further added thereto and, while thoroughly stirring, continuously introduced to the 660 ml autoclave, into which the above catalyst was introduced, via a pressure regulating valve adjusted to 0.19 MPa, and polymerization was conducted at 60° C. for 1 hour.

One hour later, the continuous feed of the raw material gases of propylene and ethylene was halted and the autoclave was depressurized to purge the unreacted gas with nitrogen. The polymerized solution was transferred to a 100 ml separating funnel, washed with a 3N—HCl aqueous solution and brine. The organic layer was dried over magnesium sulfate. Magnesium sulfate was separated by filtration under reduced pressure. The toluene solution was condensed under reduced pressure to obtain a clear liquid.

The catalytic efficiency was 200 kg oligomer/mol metal, the number average molecular weight Mn was 1500 and the weight average molecular weight Mw was 3600. Mw/Mn was 2.4. The molar ratio of ethylene to propylene E/P in the oligomer was 1.1.

### Example 2

A 660 ml autoclave equipped with an electromagnetic stirrer was thoroughly dried at 110° C. under reduced pressure in advance. Dry toluene (30 ml), a solution of methylaluninoxane in hexane (2.7 mmol in terms of Al) and a solution of diethylzinc in toluene (2.7 mmol) were introduced thereto under nitrogen.

Under nitrogen, rac-ethylidenebisindenylzirconium dichloride (12 μmol), the iron complex (II) (25 μmol), and 20 ml of dry toluene were introduced to a 50 ml eggplant flask. Methylaluminoxane (2.7 mmol in terms of Al) was added to the toluene solution. The obtained solution was introduced into the autoclave with a temperature adjusted to 60° C. in a water bath to prepare the first catalyst.

A 2-L autoclave thoroughly dried in advance was charged with propylene (0.6 MPa), ethylene (0.3 MPa) was further added thereto and, while thoroughly stirring, continuously introduced to the 660 ml autoclave, into which the catalyst composition was introduced, via a pressure regulating valve adjusted to 0.19 MPa, and polymerization was conducted at 60° C. for 1 hour.

One hour later, the continuous feed of the starting gas of propylene and ethylene was halted and the autoclave was depressurized to purge the unreacted gas with nitrogen. The polymerized solution was transferred to a 100 ml separating funnel, washed with a 3N—HCl aqueous solution and brine. The organic layer was dried over magnesium sulfate. Magnesium sulfate was separated by filtration under reduced pressure. The toluene solution was condensed under reduced pressure to obtain a clear liquid.

The catalytic efficiency was 238 kg oligomer/mol metal, the number average molecular weight Mn was 1600 and the weight average molecular weight Mw was 3700. Mw/Mn was 2.3. The molar ratio of ethylene to propylene E/P in the oligomer was 1.0.

### Comparative Example 1

A 660 ml autoclave equipped with an electromagnetic stirrer was thoroughly dried at 110° C. under reduced pressure in advance. Dry toluene (30 ml) and a solution of triisobutylaluminum in toluene (1M solution, 1.4 mmol in terms of Al) were introduced thereto under nitrogen.

Under nitrogen, rac-ethylidenebisindenylzirconium dichloride (14 μmol), and 20 ml of dry toluene were introduced to a 50 ml eggplant flask. Methylaluminoxane (1.4 mmol in terms of Al) was added to the toluene solution. The obtained solution was introduced into the autoclave with a temperature adjusted to 60° C. in a water bath to prepare a catalyst composition.

A 2-L autoclave thoroughly dried in advance was charged with propylene (0.6 MPa), ethylene (0.30 MPa) was further added thereto and, while thoroughly stirring, continuously introduced to the 660 ml autoclave, into which the catalyst composition was introduced, via a pressure regulating valve adjusted to 0.19 MPa, and polymerization was conducted at 60° C. for 1 hour.

One hour later, the continuous feed of the starting gas of propylene and ethylene was halted and the autoclave was depressurized to purge the unreacted gas with nitrogen. The polymerized solution was transferred to a 100 ml separating funnel, washed with a 3N—HCl aqueous solution and brine. The organic layer was dried over magnesium sulfate. Magnesium sulfate was separated by filtration under reduced pressure. The toluene solution was condensed under reduced pressure to obtain a clear liquid.

The catalytic efficiency was 500 kg oligomer/mol metal, the number average molecular weight Mn was 5200 and the weight average molecular weight Mw was 16000. Mw/Mn was 3.1. The molar ratio of ethylene to propylene E/P in the oligomer was 0.7.

### Comparative Example 2

A 660 ml autoclave equipped with an electromagnetic stirrer was thoroughly dried at 110° C. under reduced pressure in advance. Dry toluene (30 ml) and a solution of methylaluminoxane in hexane (0.11 mmol in terms of Al) were introduced thereto under nitrogen.

Under nitrogen, the iron complex (II) (0.57 μmol), and 20 ml of dry toluene were introduced to a 50 ml eggplant flask. Methylaluminoxane (0.17 mmol in terms of Al) was added to the toluene solution. The obtained solution was introduced into the autoclave with a temperature adjusted to 60° C. in a water bath to prepare a catalyst composition.

A 2-L autoclave thoroughly dried in advance was charged with propylene (0.6 MPa), ethylene (0.3 MPa) was further added thereto and, while thoroughly stirring, continuously introduced to the 660 ml autoclave, into which the catalyst composition was introduced, via a pressure regulating valve adjusted to 0.19 MPa, and polymerization was conducted at 60° C. for 1 hour.

One hour later, the continuous feed of the starting gas of propylene and ethylene was halted and the autoclave was depressurized to purge the unreacted gas with nitrogen. 500 ml of toluene was added to the polymerization reaction solution, the toluene solution was transferred to a 1000 ml separating funnel, washed with a 3N—HCl aqueous solution and brine. The organic layer was dried over magnesium sulfate. Magnesium sulfate was separated by filtration under reduced pressure. The toluene solution was condensed under reduced pressure to obtain an opaque semi-solid.

The catalytic efficiency was 5218 kg oligomer/mol metal, the number average molecular weight Mn was 270 and the weight average molecular weight Mw was 570. Mw/Mn was 2.1. The molar ratio of ethylene to propylene E/P in the oligomer was 10.6.

<Second Catalyst Production and Oligomer Production>

### [Preparation of Ingredients]

2,6-Dicyanopyridine, a product of Aldrich, was used as it was. 4-Bromoanisole, a solution of phenylmagnesiumbromide in THF, a solution of trimethylaluminum in toluene, 2-methyl-4-methoxyaniline, 2,4-dimethylaniline, orthotoluidine and 2,6-diacetylpyridine, products of Tokyo Chemical Industry Co., Ltd., were used as received. Methylaluminoxane, a product of Tosoh Finechem Corporation, TMAO-341, was used as it was. For ethylene, high purity liquefied ethylene, a product of Sumitomo Seika Chemicals, Co., Ltd., dried through molecular sieve 4A was used. For toluene as the solvent, dry toluene, a product of Wako Pure Chemical Industries, Ltd., was used as it was.

[Measurement of the Number Average Molecular Weight (Mn) and the Weight Average Molecular Weight (Mw)]

Two columns (PL gel 10 m MIXED-B LS) were connected to a high temperature GPC apparatus (a product of Polymer Laboratories Ltd., tradename: PL-220) with refractive index detector. 5 ml of 1-chloronaphthalene solvent was added to 5 mg of a sample and stirred with heating at 220° C. for about 30 minutes. The thus dissolved sample was measured at a flow rate set to be 1 ml/min and a column oven temperature to be 210° C. The molecular weight conversion was carried out based on a calibration curve prepared from a standard polystyrene and a molecular weight in terms of polystyrene was determined.

[Catalytic Efficiency Calculation]

The catalytic efficiency was calculated by dividing the weight of the obtained oligomer by the number of moles of the catalyst fed.

### Synthesis of 2,6-dibenzoylpyridine

2,6-Dibenzoylpyridine was synthesized in accordance with the method described in Journal of Molecular Catalysis A: Chemical 2002, 179, 155. Specifically, a solution of phenylmagnesiumbromide in THF (40 mmol) was introduced to a 200 ml eggplant flask under a nitrogen atmosphere. The solution was ice-cooled, to which a solution of 2,6-dicyanopyridine (40 mmol) in ether (40 ml) was added dropwise over a period of 1 hour and further stirred for 20 hours. After confirming the disappearance of the raw materials by TLC, 1M sulfuric acid was added to dissolve the salt and the solvent was removed using an evaporator. The resultant mixture was transferred to a separating funnel and extracted with toluene. The toluene layer was washed with a saturated sodium hydrogen carbonate aqueous solution and brine and dried over anhydrous magnesium sulfate. After separating the anhydrous magnesium sulfate by filtration, the filtrate was condensed under reduced pressure. The residue was purified by column chromatography to obtain 2,6-dibenzoylpyridine in a yield of 42%.

### Synthesis of 2,6-pyridinediyl-bis(4-methoxyphenylmethanone)

The same operation as in Production Example 1 was carried out except that Grignard obtained by introducing, in place of phenylmagnesiumbromide, 4-bromoanisole (4 mmol) and metal magnesium (45 mmol) to a THF solution (40 ml) under a nitrogen atmosphere was used, thereby obtaining 2,6-pyridinediyl-bis(4-methoxyphenylmethanone) in a yield of 50%.

[Synthesis of Diimine Compound (3-1)]

2-Methyl-4-methoxyaniline (1.276 g, 9.3 mmol, FM=137) was introduced to a 100 ml eggplant flask under a nitrogen atmosphere and dissolved in 20 ml of dry toluene. A solution of trimethylaluminum in toluene (1.8 M, 5.2 ml, 9.3 mmol) was slowly added thereto and reacted for 2 hours by heating under reflux with toluene. After cooling the reaction solution to room temperature, 2,6-dibenzoylpyridine (1.439 g, 4.7 mmol, FM=287) synthesized in Production Example 1 was added thereto and heated again to reflux for 6 hours.

After completing the reaction, the reaction solution was cooled to room temperature and a 5%-NaOH aqueous solution was added thereto to completely decompose aluminum. The NaOH layer was separated using a separating funnel from the solution thus divided into two layers and the organic layer was washed with brine. The washed toluene solution was dried over anhydrous magnesium sulfate. After filtrating the inorganic substances, the toluene solution was condensed by using an evaporator. The residue was purified by silica gel column chromatography (developing solvent:hexane/ethyl acetate=10/1) to obtain the intended diimine compound (3-1) in a yield of 64%. Note that the purity was confirmed by GC and the peak at MS 525 was also confirmed by GC-MS.

[Synthesis of Diimine Compound (3-2)]

The same operation as in the above Synthesis of diimine compound (3-1) was carried out except that 2,4-dimethylaniline (FM=121) was used in place of 2-methyl-4-methoxyaniline, thereby obtaining the intended diimine compound (3-2). The peak at MS 493 was confirmed by GC-MS.

[Synthesis of Diimine Compound (3-3)]

The same operation as in the above Synthesis of diimine compound (3-1) was carried out except that ortho-toluidine (FM=107) was used in place of 2-methyl-4-methoxyaniline, thereby obtaining the intended diimine compound (3-3). The peak at MS 465 was confirmed by GC-MS.

[Synthesis of Diimine Compound (3-4)]

The same operation as in the above Synthesis of diimine compound (3-1) was carried out except that 2,6-pyridinediyl-bis(4-methoxyphenylmethanone) (FM=347) was used in place of 2,6-dibenzoylpyridine, thereby obtaining the intended diimine compound (3-4). The peak at MS 585 was confirmed by GC-MS.

[Synthesis of Diimine Compound (3-5)]

The same operation as in the above Synthesis of diimine compound (3-4) was carried out except that 2,4-dimethylaniline (FM=121) was used in place of 2-methyl-4-methoxyaniline, thereby obtaining the intended diimine compound (3-5). The peak at MS 553 was confirmed by GC-MS.

[Synthesis of Diimine Compound (3-6)]

The same operation as in the above Synthesis of diimine compound (3-4) was carried out except that orthotoluidine (FM=107) was used in place of 2-methyl-4-methoxyaniline, thereby obtaining the intended diimine compound (3-6). The peak at MS 525 was confirmed by GC-MS.

[Synthesis of Diimine Compound (6)]

The same operation as in the above Synthesis of diimine compound (3-1) was carried out except that 2,6-diacetylpyridine was used in place of 2,6-dibenzoylpyridine, thereby obtaining a diimine compound (6). The peak at MS 401 was confirmed by GC-MS. The chemical structure of the diimine compound (6) is shown below.

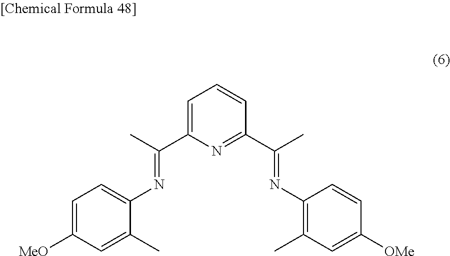 [SMILES: COc1ccc(/N=C(\C)c2cccc(/C(C)=N/c3ccc(OC)cc3C)n2)c(C)c1]

### Example 3

The diimine compound (3-1) (1 mmol) was dissolved in 10 ml of dry tetrahydrofuran in a 50 ml eggplant flask under a nitrogen atmosphere. Iron(II) chloride tetrahydrate (1 mmol) was dissolved in 10 ml of dry tetrahydrofuran in another 100 ml eggplant flask under a nitrogen atmosphere. The solution of the diimine compound was added to this solution and the resultant solution was stirred at room temperature for 12 hours. After completing the reaction, the solvent was evaporated to obtain solid. The solid was washed with ethanol and diethyl ether. The washed solid was thoroughly dried, thereby obtaining the expected iron complex in a yield of 40%.

A 660 ml autoclave equipped with an electromagnetic stirrer was thoroughly dried at 110° C. under reduced pressure in advance. Subsequently, dry toluene (80 ml) was introduced into an autoclave under a nitrogen gas stream and a temperature was adjusted to 25° C.

The iron complex (0.61 mmol) obtained above was dissolved in 20 ml of dry toluene in a 50 ml eggplant flask under a nitrogen gas stream to be a solution (A). A solution of methylaluminoxane in hexane (Al 3.64 M) in a 500 equivalent amount to the iron was introduced using another 50 ml eggplant flask and the hexane solvent and free trimethylaluminum were distilled off under reduced pressure. The solution (A) was added to the dried methylaluminoxane and stirred for 5 minutes thereby obtaining a solution (B) containing the catalyst. The solution (B) was added to an autoclave to which dry toluene was introduced and ethylene, regulated to 0.19 MPa, was continuously introduced at 25° C. The ethylene introduction was halted 15 minutes later, the unreacted ethylene was removed and ethylene in the autoclave was purged with nitrogen. A very small amount of ethanol was added to the autoclave. The autoclave was opened and the resultant mixture was transferred to a 200 ml eggplant flask. The solvent was distilled off under reduced pressure to obtain a semi-solid oligomer. The catalytic efficiency was 5331 kg Olig/Fe mol. Further, Mn of the obtained oligomer was 480, Mw was 920 and Mw/Mn was 1.9.

### Example 4

The same operation as in Example 3 was carried out except that the diimine compound (3-4) was used in place of the diimine compound (3-1) and the iron complex (1.5 μmol) was used in the preparation process of the solution (A). The catalyst efficiency was 5626 kg Olig/Fe mol. Further, Mn of the obtained oligomer was 440, Mw was 650 and Mw/Mn=1.5.

### Comparative Example 3

The same operation as in Example 3 was carried out except that the diimine compound (6) was used in place of the diimine compound (3-1). The catalyst efficiency was 2546 kg Olig/Fe mol. Further, Mn of the obtained oligomer was 590, Mw was 1200 and Mw/Mn=2.0.

<Third Catalyst Production and Oligomer Production>

### [Preparation of Ingredients]

The iron compound was synthesized by the method illustrated in the synthesis examples described later. Commercially available reagents were used as received. Methylaluminoxane, a product of Tosoh Finechem Corporation, TMAO-341, was used as it was. For ethylene, high purity liquefied ethylene, a product of Sumitomo Seika Chemicals, Co., Ltd., dried through molecular sieve 4A was used.

[Measurement of the Number Average Molecular Weight (Mn) and the Weight Average Molecular Weight (Mw)]

Two columns (PL gel 10 μm MIXED-B LS) were connected to a high temperature GPC apparatus (a product of Polymer Laboratories Ltd., tradename: PL-220) with refractive index detector. 5 ml of ortho-dichlorobenzene solvent was added to 5 mg of a sample and stirred with heating at 140° C. for about 90 minutes. The thus dissolved sample was measured at a flow rate set to be 1 ml/min and a column oven temperature to be 140° C. The molecular weight conversion was carried out based on a calibration curve prepared from a standard polystyrene and a molecular weight in terms of polystyrene was determined.

[Catalytic Efficiency Calculation]

The catalytic efficiency was calculated by dividing the weight of the obtained oligomer by the total number of moles of the catalyst fed.

[Synthesis of Diimine Product (II)]

2-Methyl-4-methoxyaniline (2.0893 g, 15.3 mmol) (a product of Tokyo Chemical Industry Co., Ltd.), 2,6-diacetylpyridine (1.2429 g, 7.6 mmol) (a product of Tokyo Chemical Industry Co., Ltd.), molecular sieve 4A (5.0 g) and a catalytic amount of para-toluenesulfonic acid were dispersed in dry toluene (60 ml) and stirred by heating under reflux for 24 hours while removing water using a Dean-Stark water separator.

The molecular sieve was removed from the reaction solution by filtration and washed with toluene. The washing solution and the filtered reaction solution were mixed. The combined toluene solution was condensed in vacuo to obtain a crude solid (2.8241 g). The crude solid obtained herein was weighed (2 g) and washed with anhydrous ethanol (30 ml). The solid insoluble in ethanol was separated by filtration and the obtained insoluble solid was further washed with ethanol. The remained solid was thoroughly dried, thereby obtaining the following diimine product (II) in a yield of 50%.

¹H NMR (600 MHz, CDCl₃): 2.1 (s, 6H), 2.4 (s, 6H), 3.8 (s, 6H), 6.6 (m, 2H), 6.7 (m, 2H), 6.8 (m, 2H), 7.9 (m, 1H), 8.4 (m, 2H)

¹³C NMR (600 MHz, CDCl₃): 16, 18, 56, 116, 119, 122, 125, 129, 137, 138, 143, 156, 167

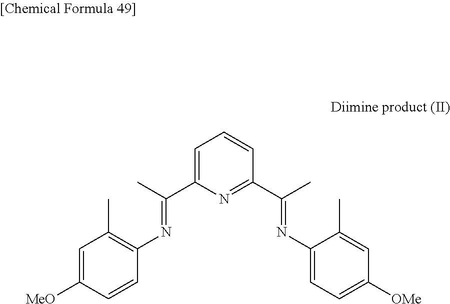 [SMILES: COc1ccc(/N=C(\C)c2cccc(/C(C)=N/c3ccc(OC)cc3C)n2)c(C)c1]

[Synthesis of Iron Complex (II)]

FeCl₂.4H₂O (0.2401 g, 1.2 mmol) (a product of Kanto Chemical Co., Inc.) was dissolved in dehydrated tetrahydrofuran (30 ml) (a product of Aldrich) and a solution of the diimine product (II) (0.4843 g, 1.2 mmol) produced earlier in tetrahydrofuran (10 ml) was added thereto. By adding the yellow diimine, the tetrahydrofuran solution instantaneously turned to dark green. Further, the solution was stirred at room temperature for 2 hours. The solvent was evaporated from the reaction mixture. The resultant solid was continuously washed with dry ethanol until the filtrate had no color. The washed solid was further washed with dry diethyl ether. The remained solvent was evaporated to obtain an iron complex. The obtained iron complex had an FD-MASS of 527.0820 (calculated value: 527.0831) suggesting the structure of the following iron complex (II).

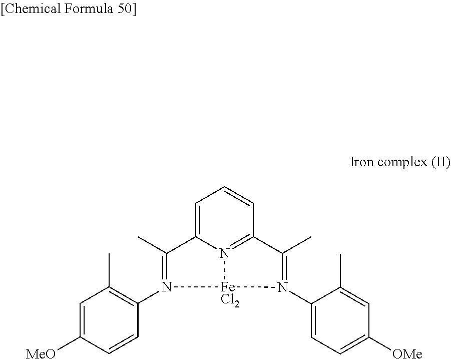

### Example 5

The iron complex II and the diimine product II obtained above were prepared respectively to be 1 mM with dry toluene in a 50 ml eggplant flask under a nitrogen gas stream. 20 ml of dry toluene was introduced in another 50 ml eggplant flask and the iron complex II solution (1 μmol) and the diimine product II solution (0.5 μmol) prepared earlier were added thereto. A solution of methylaluminoxane in hexane (3.64 M) in a 500 equivalent amount to the iron was added to this solution to prepare a catalyst.

80 ml of dry toluene was introduced into an autoclave thoroughly dried in advance and the above catalyst was added thereto. Ethylene, regulated to 0.19 MPa, was continuously introduced at 25° C. into the autoclave via a mass flow meter to start the polymerization reaction. The ethylene consumption did not stop even 1 hour had passed since the start of the polymerization and the catalytic activity was maintained after 3 hours had passed. The ethylene feed was halted 3 hours later, the unreacted ethylene was removed. The remained ethylene in the autoclave was purged with nitrogen and a very small amount of ethanol was added to the autoclave. The autoclave was opened and the resultant mixture was transferred to a 200 ml eggplant flask. The solvent was distilled off under reduced pressure to obtain a semi-solid oligomer. The catalytic efficiency was 19810 kg Olig/Fe mol. Further, Mn of the obtained oligomer was 450, Mw was 1100 and Mw/Mn was 2.4.

### Example 6

The iron complex II and the diimine product II obtained above were adjusted respectively to be 1 mM with dry toluene in a 50 ml eggplant flask under a nitrogen gas stream. 20 ml of dry toluene was introduced in another 50 ml eggplant flask and the iron complex II solution (1 μmol) prepared earlier was added thereto. A solution of methylaluminoxane in hexane (3.64 M) in a 500 equivalent amount to the iron was added to this solution. The solution was confirmed to have turned from light green to yellow and then the diimine product II solution (0.5 μm) was added thereto to prepare a catalyst.

80 ml of dry toluene was introduced into an autoclave thoroughly dried in advance and the above catalyst was added thereto. Ethylene, regulated to 0.19 MPa, was continuously introduced at 25° C. into the autoclave via a mass flow meter to start the polymerization reaction. The ethylene consumption did not stop even 1 hour had passed since the start of the polymerization and the activity was maintained after 3 hours had passed. The ethylene feed was halted 3 hours later, the unreacted ethylene was removed, ethylene in the autoclave was purged with nitrogen and a very small amount of ethanol was added. The autoclave was opened and the resultant mixture was transferred to a 200 ml eggplant flask. The solvent was distilled off under reduced pressure to obtain a semi-solid oligomer. The catalytic efficiency was 30025 kg Olig/Fe mol. Further, Mn of the obtained oligomer was 570, Mw was 1500 and Mw/Mn was 2.6.

### Comparative Example 4

The iron complex II obtained above was prepared to be 1 mM with dry toluene in a 50 ml eggplant flask under a nitrogen gas stream. 20 ml of dry toluene was introduced in a separate 50 ml eggplant flask and the iron complex II solution (1 μmol) prepared earlier was added thereto. A solution of methylaluminoxane in hexane (3.64 M) in a 500 equivalent amount to the iron was added to this solution to prepare a catalyst. The solution was confirmed to have turned from light green to yellow.

80 ml of dry toluene was introduced into an autoclave thoroughly dried in advance and the above catalyst was added thereto. Ethylene, regulated to of 0.19 MPa, was continuously introduced at 25° C. into the autoclave via a mass flow meter to start the polymerization reaction. The ethylene consumption stopped after 1 hour had passed since the start of the polymerization. The unreacted ethylene was removed, ethylene in the autoclave was purged with nitrogen and a very small amount of ethanol was added. The autoclave was opened and the resultant mixture was transferred to a 200 ml eggplant flask. The solvent was distilled off under reduced pressure to obtain a semi-solid oligomer. The catalytic efficiency was 7900 kg Olig/Fe mol. Further, Mn of the obtained oligomer was 440, Mw was 650 and Mw/Mn was 1.5.

1. A method for producing an oligomer, the method comprising a step of co-oligomerizing a polymerizable monomer including ethylene and an α-olefin in the presence of a catalyst comprising:
(A) a rac-ethylidene indenyl zirconium compound represented by the following formula (1);
(B) an iron compound represented by the following formula (2);
(C) methylaluminoxane and/or a boron compound; and
(D) an organozinc compound and/or an organoaluminum compound other than methylaluminoxane: 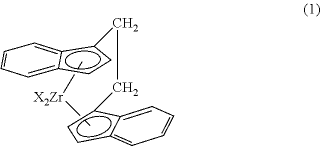
wherein X is a halogen atom, a hydrogen atom or a hydrocarbyl group having 1 to 6 carbon atoms; 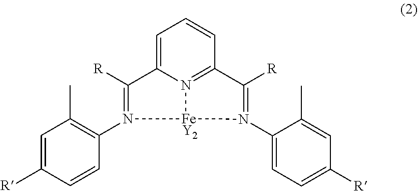
wherein R is a hydrocarbyl group having 1 to 6 carbon atoms or an aromatic group having 6 to 12 carbon atoms, a plurality of Rs in the same molecule may be the same or different, R′ is a free radical having 0 to 6 carbon atoms and an oxygen atom and/or a nitrogen atom, a plurality of R′s in the same molecule may be the same or different and Y is a chlorine atom or a bromine atom.

2. The method according to claim 1, wherein a number average molecular weight (Mn) of the co-oligomer is 200 to 5000.

3. The method according to claim 1, wherein a molar ratio of ethylene/cα-olefin in the co-oligomer is within the range of 0.1 to 10.0.

4. The method according to claim 1, wherein the organoaluminum compound is at least one selected from the group consisting of trimethylaluminum, triethylaluminum, triisopropylaluminum, tripropylaluminum, tributylaluminum, triisobutylaluminum, trihexylaluminum, triphenylaluminum, diethylaluminum chloride, ethylaluminum dichloride and ethylaluminum sesquichloride.

5. The method according to claim 1, wherein the organozinc compound is at least one selected from the group consisting of dimethylzinc, diethylzinc and diphenylzinc.

6. The method according to claim 1, wherein the boron compound is at least one selected from the group consisting of trispentafluorophenylborane, lithium tetrakispentafluorophenylborate, sodium tetrakispentafluorophenylborate, N,N-dimethylanilinium tetrakispentafluorophenylborate, trityl tetrakispentafluorophenylborate, lithium tetrakis(3,5-trifluoromethylphenyl)borate, sodium tetrakis(3,5-trifluoromethylphenyl)borate, N,N-dimethylanilinium tetrakis(3,5-trifluoromethylphenyl)borate and trityl tetrakis(3,5-trifluoromethylphenyl)borate.

7. A catalyst comprising:
(A) a rac-ethylidene indenyl zirconium compound represented by the following formula (1);
(B) an iron compound represented by the following formula (2);
(C) methylaluminoxane and/or a boron compound; and
(D) an organozinc compound and/or an organoaluminum compound other than methylaluminoxane: 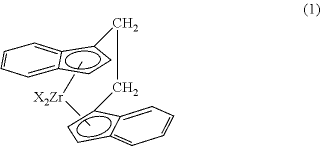
wherein X is a halogen atom, a hydrogen atom or a hydrocarbyl group having 1 to 6 carbon atoms; 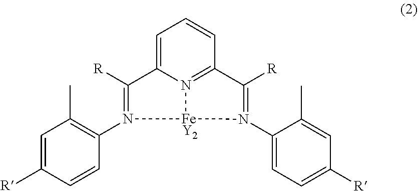
wherein R is a hydrocarbyl group having 1 to 6 carbon atoms or an aromatic group having 6 to 12 carbon atoms, a plurality of Rs in the same molecule may be the same or different, R′ is a free radical having 0 to 6 carbon atoms and an oxygen atom and/or a nitrogen atom, a plurality of R′s in the same molecule may be the same or different and Y is a chlorine atom or a bromine atom.

8. A method for producing an oligomer, the method comprising a step of oligomerizing a polymerizable monomer including an olefin in the presence of a catalyst containing a complex of a ligand being a diimine compound represented by the following formula (3) and at least one metal selected from the group consisting of Group 8 elements, Group 9 elements and Group 10 elements: 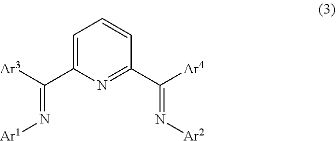
wherein Ar¹ and Ar² may be the same or different and are respectively a group represented by the following formula (4), and Ar³ and Ar⁴ may be the same or different and are respectively a group represented by the following formula (5); 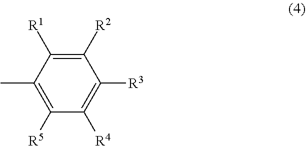
wherein R¹ and R⁵ may be the same or different and are respectively a hydrogen atom or a hydrocarbyl group having 1 to 5 carbon atoms, the total number of carbon atoms of R and R⁵ is 1 or more and 5 or less, and R², R³ and R⁴ may be the same or different and are respectively a hydrogen atom or an electron-donating group; 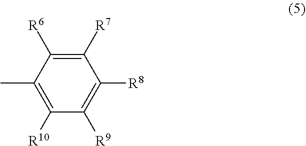
wherein R⁶ to R¹⁰ may be the same or different and are respectively a hydrogen atom or an electron-donating group.

9. The method according to claim 8, wherein the catalyst further contains an organoaluminum compound.

10. A catalyst containing a complex of a ligand being a diimine compound represented by the following formula (3) and at least one metal selected from the group consisting of Group 8 elements, Group 9 elements and Group 10 elements: 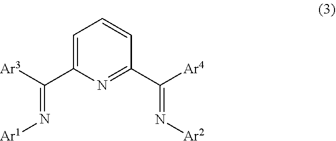
wherein Ar¹ and Ar² may be the same or different and are respectively a group represented by the following formula (4), and Ar³ and Ar⁴ may be the same or different and are respectively a group represented by the following formula (5): 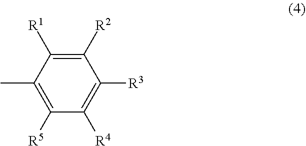
wherein R¹ and R⁵ may be the same or different and are respectively a hydrogen atom or a hydrocarbyl group having 1 to 5 carbon atoms, the total number of carbon atoms of R¹ and R⁵ is 1 or more and 5 or less, and R², R³ and R⁴ may be the same or different and are respectively a hydrogen atom or an electron-donating group; 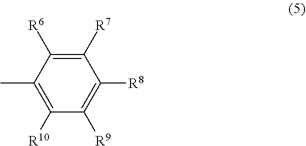
wherein R⁶ to R¹⁰ may be the same or different and are respectively a hydrogen atom or an electron-donating group.

11. A method for producing an oligomer, the method comprising a step of oligomerizing a polymerizable monomer including an olefin in the presence of a catalyst containing an iron compound represented by the following formula (2) and a compound represented by the following formula (7): 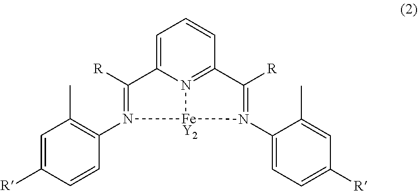
wherein R is a hydrocarbyl group having 1 to 6 carbon atoms or an aromatic group having 6 to 12 carbon atoms, a plurality of Rs in the same molecule may be the same or different, R′ is a free radical having 0 to 6 carbon atoms and an oxygen atom and/or a nitrogen atom, a plurality of R′s in the same molecule may be the same or different and Y is a chlorine atom or a bromine atom; 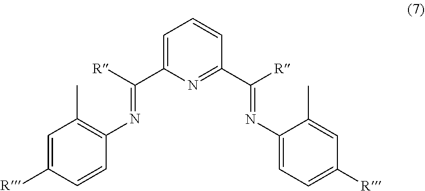
wherein R″ is a hydrocarbyl group having 1 to 6 carbon atoms or an aromatic group having 6 to 12 carbon atoms, a plurality of R″s in the same molecule may be the same or different, R′″ is a free radical having 0 to 6 carbon atoms and an oxygen atom and/or a nitrogen atom, and a plurality of R′″s in the same molecule may be the same or different.

12. A catalyst containing an iron compound represented by the following formula (2) and a compound represented by the following formula (7): 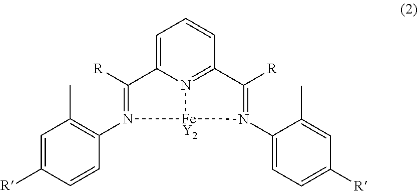
wherein R is a hydrocarbyl group having 1 to 6 carbon atoms or an aromatic group having 6 to 12 carbon atoms, a plurality of Rs in the same molecule may be the same or different, R′ is a free radical having 0 to 6 carbon atoms and an oxygen atom and/or a nitrogen atom, a plurality of R′s in the same molecule may be the same or different and Y is a chlorine atom or a bromine atom; 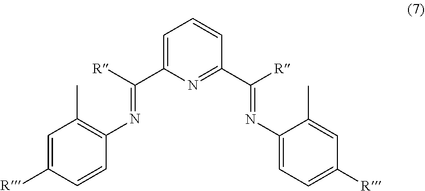
wherein R″ is a hydrocarbyl group having 1 to 6 carbon atoms or an aromatic group having 6 to 12 carbon atoms, a plurality of R″s in the same molecule may be the same or different, R′″ is a free radical having 0 to 6 carbon atoms and an oxygen atom and/or a nitrogen atom, and a plurality of R′″s in the same molecule may be the same or different.
